(19) United States
(12) Patent Application Publication
(10) Pub. No.: US 2025/0305144 A1
(43) Pub. Date: Oct. 2, 2025

(54) METHOD FOR PREPARING CONTINUOUS CARBON NANOTUBE NETWORK FILMS

(71) Applicant: INSTITUTE OF PHYSICS, CHINESE ACADEMY OF SCIENCES, Beijing (CN)

(72) Inventors: Weiya Zhou, Beijing (CN); Xin Wu, Beijing (CN); Ying Yue, Beijing (CN); Pengyu Wang, Beijing (CN); Jie Mei, Beijing (CN); Yanchun Wang, Beijing (CN)

(21) Appl. No.: 19/092,169

(22) Filed: Mar. 27, 2025

(30) Foreign Application Priority Data
Mar. 28, 2024 (CN) 202410369175.3

(51) Int. Cl. C23C 18/12; B82Y 30/00; B82Y 40/00; C23C 18/04

(52) U.S. Cl. CPC C23C 18/127; B82Y 30/00; B82Y 40/00; C23C 18/04; C23C 18/1295

(57) ABSTRACT

Provided is a method for preparing a continuous carbon nanotube (CNT) network film, comprising: preparing CNT dispersion by placing a preset amount of CNT powder in a preset dispersion medium; obtaining an original CNT film with discrete and loosely lapped CNTs by placing the CNT dispersion on a surface of a substrate; placing the original CNT film with the substrate in a chamber of a heating furnace; setting a heating program to promote interaction between the original CNT film and the substrate, thereby causing the CNTs in the original CNT film to assemble into a whole continuous Y-type interconnected network with a long common segment under driving of the facets. The transparency, electrical conductivity, mechanical properties, and other properties of the assembled continuous CNT network film are enhanced, and whole, large-area, flexible and free-standing assembled continuous CNT network films with unlimited length and width is prepared.

### CROSS-REFERENCE TO RELATED APPLICATIONS

The present application claims priority to Chinese patent application No. 202410369175.3 entitled “Method for preparing continuous carbon nanotube network films”, filed on Mar. 28, 2024, the entire contents of which are incorporated herein by reference.

### TECHNICAL FIELD

The present application relates to the field of materials technology, and particularly to continuous carbon nanotube network films and a preparation method thereof.

### BACKGROUND

Flexible Transparent Conductive Film (FTCF) is widely utilized in modern electronic devices, including display panels for various electronic terminals, dimming windows for smart buildings, defrosters for car and aircraft glass in the transportation sector, and solar cells in the energy industry. Transparency, conductivity, and mechanical properties such as flexibility and tensile strength are crucial parameters for FTCF. These properties depend on the coverage rate of the conductive material, its density/thickness, and the structure of the conductive network. Indium tin oxide (ITO) possesses excellent electrical and optical properties and is currently the most extensively used transparent conductive material. However, indium reserves are limited and it is considered a non-renewable resource. This hinders low-cost sustainable production of ITO. Additionally, ITO's brittleness and high areal density make it challenging to use in cutting-edge fields such as flexible displays, wearable devices, and aerospace applications that require flexibility and lightweight characteristics.

In the past few decades, various conductive nanomaterials such as conductive polymers, MXene, graphene, metal nanoparticles, carbon nanotubes (CNTs), and metal nanowires have been utilized in the fabrication of FTCF due to their outstanding electrical conductivity and solution processability. Among these materials, CNT is considered the most competitive ideal material owing to its exceptional electrical and optical properties, flexibility, remarkable stability, as well as characteristics essential for future military and aerospace applications including lightweight, radiation resistance, and superior fatigue endurance. Furthermore, achieving widespread application of FTCF not only demands excellent physical properties but also necessitates large-scale or even industrial production capability. CNT itself can be produced on a large scale with various forms of already available dispersants, which holds potential for industrial-scale production.

In general, CNT FTCF is primarily prepared through two conventional approaches: one is direct growth methods including arc discharge, laser ablation, and chemical vapor deposition (CVD); the other is powder-based film formation, and among various physical and chemical methods, the solution/slurry-based deposition (SBD) method is most commonly used for forming films by utilizing CNT dispersion agents through coating. However, both the CVD and SBD methods face limitations in achieving large-scale production of CNT FTCF with excellent transparent conductive properties that meet industrial requirements. While direct growth methods can yield CNT FTCF with superior physical properties, their scalability is restricted and costs are high. On the other hand, although the SBD method demonstrates the potential for large-scale industrial production due to its wide range of dispersants and low cost, it has limited means to enhance the physical properties of CNT FTCF or control its structure. Particularly challenging is addressing weak interactions and disorderly loose connections between dispersed CNTs.

The evolving field of device manufacturing, especially in next-generation flexible electronics/devices, flexible optoelectronics/devices, and wearable devices/systems has imposed increasingly higher demands on the physical properties and application extensibility of FTCF. These demands require FTCF to possess not only outstanding transparency and conductivity but also flexibility, high strength, and even free-standing transfer capabilities, meanwhile to be amenable to mass production without area restrictions, thus providing an effective solution to the key technical problem of large-scale FTCF, which has been a bottleneck.

Therefore, it holds great scientific significance and practical value to develop a method of connecting loosely X-type lapped or relatively independent CNTs into a continuous network structure to enhance transparency, conductivity, and mechanical properties, meanwhile achieving scalable production of CNT FTCF without constraints on production area size.

### SUMMARY

In light of the issues above, this invention presents a method for preparing a continuous CNT network film that effectively addresses or at least partially resolves the mentioned challenges.

One of the aims of this invention is to realize a large-scale production of continuous CNT network films.

A further objective of the invention is to prepare a continuous CNT network film with superior performance based on CNT powder.

Specifically, the invention offers a method for preparing a continuous CNT network film, comprising:
preparing CNT dispersion by placing a preset amount of CNT powder in a preset dispersion medium;
obtaining an original CNT film with discrete and loosely lapped CNTs by placing the CNT dispersion on a surface of a substrate;
placing the original CNT film and the substrate into a chamber of a heating furnace; and
setting up a heating program to initiate an interaction between the original CNT film and the substrate, thereby assembling the CNTs in the original CNT film into an assembled continuous CNT network film.

Optionally, wherein the steps following placing the CNT dispersion on a surface of a substrate further comprise:
dripping a volatile organic solvent onto the original CNT film to infiltrate the original CNT film to increase the contact between the discrete and loosely lapped CNTs and the surface of the substrate; and
performing the step of placing the original CNT film and the substrate into a chamber of a heating furnace after the organic solvent is volatilized.

Optionally, wherein CNTs in the CNT powder comprise a mixture of any one, or any combination of the following: single-walled, double-walled, few-walled, and multi-walled CNTs;
an areal density of the dispersed CNTs exceeds a predetermined value, resulting in a sheet resistance of less than 10,000Ω/□ after the dispersion is placed on the surface of the substrate;
the CNT dispersion comprises dispersion in atmosphere, dispersion in liquid or spreading of CNT powder;
a method of placing the CNT dispersion on the surface of the substrate includes any one, or any combination of the following methods: fluidized bed vapor deposition, powder coating deposition, powder vapor spraying, coating, blade coating, spraying, drop casting, centrifugal film deposition, and powder dipping.

Optionally, wherein the processes of initiating the interaction between the original CNT film and the substrate include:
allowing the substrate to undergo surface reconstruction in the presence of gas in the chamber of the heating furnace during heating to form a microstructure called a ‘facet’ concurrent with transport of atoms constituting facets, the facets showing a regular stepped or zigzag pattern at a mesoscopic scale on the surface of the substrate;
allowing the facets to interact with the original CNT film to eliminate impurities from the original CNT film, and to compel at least a portion of the CNTs in the original CNT film to relocate, thereby making adjacent CNTs or bundles turn into tight proximity, facilitating the assembly of a continuous network in the original CNT film, thus obtaining the assembled continuous CNT network film.

Optionally, wherein the gas is a gas, in the chamber of the heating furnace, that is capable of interacting with the substrate to initiate the surface reconstruction, and includes any one or a mixture of oxidizing gases, or any one or a mixture of reducing gases;
a source of the gas includes any one of the forms of gas, liquid, and solid, or any combination of the above multiple forms.

Optionally, wherein allowing the substrate to undergo surface reconstruction in the presence of gas in the chamber of the heating furnace during heating to form the facets includes:
purging the chamber of the heating furnace to regulate a partial pressure of the gas in the chamber of the heating furnace, which can interact with the substrate to result in the surface reconstruction, to be within a predetermined range; and
heating the chamber to control the substrate to undergo surface reconstruction with the gas, so as to form the facets.

Optionally, wherein allowing the facets to interact with the original CNT film includes:
continuing heating the chamber to promote gradual growth of the facets on the surface of the substrate, thereby facilitating gradual tight adhesion of at least a portion of the CNTs in the original CNT film to the facets, as well as gradual dissolution of impurities within the original CNT film;
the CNTs in the original CNT film moving closer to each other as the facets grow up, leading to assembly of the CNTs into a Y-type interconnected network with a long common segment under driving of the facets, thus obtaining a whole assembled continuous CNT network film.

Optionally, wherein after allowing the facets to interact with the original CNT film, the method further comprises:
cooling the assembled continuous CNT network film at a predetermined cooling rate;
etching the substrate from the assembled continuous CNT network film by placing them in a substrate etchant after cooling, allowing the assembled continuous CNT network film to float on surface of the substrate etchant, and then rinsing the film.

Optionally, wherein before placing the CNT dispersion on the surface of the substrate, the method further comprises:
pretreating the substrate to make a surface of the substrate smooth by any one of methods including mechanical polishing, electrochemical polishing, and high-temperature annealing or a combination of any of the above methods.

The method for preparing a continuous CNT network film, as presented in the present invention, comprises the following steps: firstly, obtaining a predetermined amount of CNT powder and placing it in a predetermined dispersion medium to prepare a CNT dispersion; placing the CNT dispersion on a surface of a substrate to form an original CNT film in which the CNTs are discrete and loosely lapped; subsequently placing the original CNT film and the substrate into a chamber of a heating furnace; setting a heating program to initiate an interaction between the original CNT film and the substrate, thereby causing the CNTs in the original CNT film to assemble into an assembled continuous CNT network film.

In some further embodiments, after placing the original CNT film and the substrate into a chamber of a heating furnace, the surface of the substrate undergoes surface reconstruction with the gas and forms facets. With transport of facet atoms, the facets originate from an imperceptible state and gradually expand, showing a regular stepped or zigzag pattern (a continuous, uniformly spaced and periodically repeated step-like morphology) at the mesoscopic scale on the surface. Meanwhile, interactions between the facets and the original CNT film take place, including the following processes under certain conditions (temperature, atmosphere, etc.): as the facets on the surface of the substrate gradually expand, the transport of a large number of atoms or molecules constituting these facets initiates movement of CNTs (referred to as driving of the facets) along with impurities, which causes the CNTs to gradually adhere to the facets, leading to progressive dissolution and eventual elimination of impurities from the original CNT film. Simultaneously, at least a portion of the CNTs in the original CNT film relocates under driving of the facets, facilitating assembly of CNTs, thus obtaining an assembled continuous CNT network film. Within a certain temperature range, these interactions may occur and proceed separately one or more at a time, or simultaneously, or in an interwoven manner.

Original CNT films usually contain impurities of various types, including dispersants, stabilizers, additives and other organic impurities from raw materials, trace amounts of metals or inorganic salts, defective CNTs, thin and weak CNTs, catalyst particles and amorphous carbon within the CNTs. Owing to diverse nature of different impurities, conditions under which facets interact with these impurities exhibit variability. Typically, a minimum temperature at which facets interact with any given impurity is designated as T_{L}. On the facets, intense atomic migration and transport lead to rapid dissociation of impurities such as dispersants and organic substances into smaller units like gases, water, inorganic compounds, or amorphous carbon at certain temperatures, i.e., decomposition. On the other hand, impurities including metals, inorganic salts, amorphous carbon, catalyst particles, defective or weak CNTs tend to rapidly integrate into the facets through processes such as alloying, diffusion, and solid solution formation under driving of the facets, i.e., dissolution.

Under an applicable atmosphere that can undergo surface reconstruction with the substrate in a certain temperature range, the aforementioned interactions may occur singly, or simultaneously, or in an interwoven manner. The sequence of occurrence of these processes is influenced by driving of the facets, which embodies in the various stages from the formation to expansion of the facets, as well as their different processes of interactions with the original CNT film (which contains impurities), all of which are related to the intrinsic properties of the facets, impurities, and CNTs. The following is a comprehensive explanation:

(1) When the temperature Tₓ reaches T₁ (the temperature at which the facets begin to appear on the selected substrate), facets start to emerge on the surface of the substrate. The temperature range for facets formation is set as Tₓ≥T₁. When Tₓ=T₁, as atoms or molecules constituting facets on the surface of the substrate undergo transport, the interaction between the facets and the original CNT film commences. Due to the limited size of the facets at this stage, the overall probability of transported atoms or molecules interacting with the original CNT film is relatively low, rendering this interaction inconspicuous. Consequently, when Tₓ=T₁, the assembly process remains inconspicuous or incomplete, and the CNTs within the original CNT film have yet to form common segments and network structures. At this stage, the CNTs in the original film are randomly and disorderly distributed and overlapped. The spaces between them are not continuous pores formed by a network structure, but rather random and non-uniform gaps. Consequently, these characteristics prevent the attainment of desirable physical properties, especially for robust mechanical performance. As the temperature continues to rise, i.e., Tₓ>T₁, the facets progressively increase in size, with their boundaries expanding. This expansion leads to the gradual convergence of boundaries between some or even most adjacent facets, resulting in the formation of distinct stepped or zigzag morphologies on the surface of the substrate. During the progressive growth of the facets, accompanied by the transport of atoms or molecules constituting facets, at least a portion of the CNTs in the original CNT film gradually adhere to the facets. As the facets grow, their boundaries expand and gradually converge until they eventually come into contact. The CNTs adhering to the facets, along with impurities in the original CNT film, are compelled to relocate by the expanding facet boundaries. This interaction between the facets and the CNTs results in the migration of some CNTs to the contact areas between the facets, leading to the initial formation of common segments of CNTs. Impurities move during the growth of facets, shortening the distance from the facets and facilitating the interaction between them. In this case, spaces between the CNTs expand resulted by the movement of CNTs and impurities, as well as the initial formation of common segments, thereby forming sporadically distributed individual or a few consecutive pores.

When Tₓ≥T_{L}, a portion of the impurities gradually interact with the facets. Therefore, during this process, the areal density of the film initially decreases. As the temperature continues to increase, specifically when Tₓ>>T₁, the assembly process becomes increasingly conspicuous. This is manifested by the expansion of facet edges during heating, leading to increased contact areas between them. Under driving of the facets, some CNTs in the original CNT film gradually adhere to the facets, subsequently moving and assembling to form extended common segments at the areas of contact. At this stage, with Tₓ>T_{L}, the facets continuously dissolve impurities adhering to them, including defective CNTs, weak or thin CNTs, catalyst particles, and amorphous carbon, thereby facilitating the assembly of a portion of fresh Y-type interconnected continuous network with a long common segment.

(2) When the temperature Tₓ continues to rise from T₁ to T₂ (the temperature at which the facets start to grow conspicuously, the grooves and depressions between the facets further expand, eventually forming regular and well-aligned stepped or zigzag morphologies), the growth rate of the facets transitions from gradual to rapid and the edges of the facets contact with each other after expansion. As the contact areas continue to increase, the grooves and depressions between the facets form and eventually result in regular and well-aligned stepped or zigzag morphologies. During this process, the interactions between the original CNT film (containing impurities) and the facets become more conspicuous. The CNTs, along with their impurities, move and approach the facets under driving of the facets (that is, the transport of a large number of atoms or molecules constituting the facets causes the CNTs containing impurities to move). In this period, spaces between CNTs further expand. The pores begin to transition from sporadic distribution to many interconnected networks within localized regions, promoted by CNT movement, impurity elimination, and the initial formation of continuous network as the facets grow up. Therefore, at Tₓ=T₂, it is essential to maintain the temperature for a certain duration to ensure that the facet growth process has adequate time to proceed, meanwhile allowing the conspicuous interactions to persist for a sufficient period, thereby ensuring their completion to a greater extent.

The assembly process is conspicuous, manifested as follows: Under driving of the facets, more and more CNTs in the original CNT film adhere tightly to the facets and then undergo obvious movement. The majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. For some short CNTs, under the influence of driving of the facets, they gather at the grooves and depressions formed at the facet steps, and adjacent short CNTs or CNT bundles tend to converge towards each other, forming bundles of larger diameter constrained by van der Waals forces. With an appropriate CNT density, the larger-diameter bundles converge and form long bundles, encircling the facet steps. The long bundles form common segments at where they gather and pores at where they separate. The facts are in close proximity to one another, causing the pores to be adjacent to each other, making the adjacent long bundles form Y-type connections, thereby forming a continuous Y-type interconnected network. By conducting a conspicuous assembly process at a constant temperature of Tₓ=T₂ for a certain duration, the original CNT film forms a large-area, Y-type interconnected network with a long common segment through the interaction between facets and the CNTs along with impurities within it. At this stage, a fully assembled CNT network has already formed. Consequently, the many small networks within localized regions evolve to extensively connected networks, eventually forming one fully interconnected network as the assembly process under driving of the facets proceeds in the isothermal duration. Since the pore boundaries in an assembled network arc formed by either long common CNT segments and CNT Y-type connections in facet grooves and depressions or CNT bundles crossing several facets, or a combination of both, combined with the regulating conditions including the original CNT density and the assembly duration, their sizes are related to their possible geometries: narrow elongated pores matching single facet-terrace dimensions and wider expanded pores crossing multiple facet steps.

When the temperature increases to T₂, where typically T₂>T_{L}, under this condition, the intense transport of a substantial number of atoms or molecules constituting facets effectively removes the impurities in the original CNT film, further decreasing its areal density. Since the defective CNTs and bundles in the original CNTs are effectively eliminated owning to the tight adhesion to the facets resulted by driving of the facets, the pore diameters (also known as pore size) of the assembled network change. Meanwhile, with their boundaries mostly formed by long common CNT segments and CNT Y-type connections converging in facet grooves and depressions, the pores generally align along the edges of the facet steps, which means the pore size is constrained by driving of the facets as the facets grow and contact each other. Consequently, except for a few pore diameters that do not change conspicuously, most pore diameters become larger or smaller to a certain extent due to impurity elimination and facet constraints. Therefore, under the dual effect of eliminating impurities of various types (including dispersants, stabilizers, additives and other organic impurities from the raw materials, trace amounts of metals or inorganic salts, defective CNTs and bundles, thin and weak CNTs, catalyst particles and amorphous carbon within the CNTs) and facet boundary constraints, both of which are resulted from driving of the facets, the network structure of the assembled continuous CNT network film is optimized, and the pore diameter becomes more uniform.

(3) The interaction process between the facets and the original CNT film also involves the following: as the temperature Tₓ increases from T₂ to T₃ (the temperature at which the selected surface of the substrate begins to melt), the morphological characteristics of the facets start to diminish. When the heating temperature Tₓ≥T₃, which marks the temperature range wherein the morphological characteristics of the facets progressively diminish, the assembly process of the CNT network is essentially complete. During this process, as T₃ approaches or reaches the substrate's melting point, the pre-melting of the surface of the substrate becomes increasingly conspicuous, and the atomic or molecular transport at the facets intensifies. Residual impurities in the already formed CNT network, such as catalyst particles, defects, and weak CNTs, are further eliminated. This removal process intertwines with the earlier impurity elimination processes, ultimately preserving the assembled CNT network structure while almost completely eliminating impurities, thus enhancing pore size uniformity, and reducing the film's areal density. Consequently, a whole and completely assembled continuous CNT network film is obtained.

The situation in which the original CNT film is placed on the surface of the substrate exhibits regional variations at both microscopic and mesoscopic scales, leading to differing interaction processes. Consequently, the aforementioned three steps may occur separately, concurrently, or in an intertwined manner under specific conditions during the entire interaction process between the facets and the original CNT film.

The assembled continuous CNT network film obtained by this method can be used as a CNT flexible transparent conductive film (i.e., CNT FTCF), which can optimize the network structure from the microscopic level by driving the loose X-type lapped CNTs to assemble into a Y-type interconnected continuous network with a long common segment. This can enhance the transparency, conductivity, and mechanical properties of CNT FTCF synergistically. This approach uses a method of placing CNT powder on a substrate to obtain an initial structure of loose X-type lapped CNTs and CNT bundles, since the substrate area is not constrained, this approach is scalable, enabling the production of CNT FTCFs with unrestricted lengths and widths, thereby facilitating large-scale and mass production.

Moreover, the method for preparing the continuous CNT network film in this invention involves setting a heating program for the chamber of the heating furnace, which induces surface reconstruction of the substrate through interaction with the gas in the chamber, leading to the migration of atoms and formation of facets that show regular stepped or zigzag features at a mesoscopic scale on the surface of the substrate. Subsequently, these facets interact with the original CNT film to eliminate impurities, meanwhile promote the relocation of the CNTs and their formation of common segments, resulting in their assembly into an interconnected network structure. The assembled continuous CNT network film obtained by this method, serving as a transparent conductive film, processes a more efficient internal conductive network compared to the conventional CNT film, which not only improves the performance of the transparent conductive film but also offers free-standing capability. Furthermore, during the assembly process under driving of the facets, impurities such as defects and weak CNTs are effectively eliminated. Combined with the constraint of facet size, this elimination process results in a more uniform pore size within the assembled continuous CNT network and a reduced areal density, thereby achieving a more lightweight structure. By modulating parameters such as the initial density of the original CNT film, the length of the original CNTs, and the interaction time between the facets and the CNTs (including impurities) in the original film, the areal density and porosity of the CNT FTCF can be precisely customized through effects derived from driving of the facets.

Upon reviewing the detailed description of a specific embodiment of the present invention in conjunction with the accompanying drawings, those skilled in the art will gain a more comprehensive understanding of the aforementioned content as well as other objectives, advantages, and features of the present invention.

### BRIEF DESCRIPTION OF DRAWINGS

The subsequent text will elaborate on certain specific embodiments of the present invention in detail by way of example rather than limitation, with reference to the accompanying figures. The consistent use of reference numerals in the drawings indicates identical or similar components or parts. Those skilled in the art need to recognize that the figures may not necessarily be drawn to scale. For the accompanying figures provided, wherein:

FIG. 1 is a flowchart outlining the process for preparing a continuous CNT network film in accordance with one embodiment of the present invention;

FIG. 2 is a flowchart outlining the process for preparing a continuous CNT network film in accordance with another embodiment of the present invention;

FIG. 3A shows an SEM image of copper facets on surface with a scale bar of 2 μm, from the method for preparing a continuous CNT network film according to an embodiment of the present invention, wherein SEM image refers to the image generated by a Scanning Electron Microscope (SEM);

FIG. 3B shows an SEM image of copper facets on surface with a scale bar of 500 nm, from the method for preparing a continuous CNT network film according to one embodiment of the present invention;

FIG. 4A is a schematic illustration of the beginning of the facet growth, from the method for preparing a continuous CNT network film according to one embodiment of the present invention;

FIG. 4B is a schematic illustration of the progressive development of the facets, from the method for preparing a continuous CNT network film according to one embodiment of the present invention;

FIG. 4C is a schematic illustration of the interaction between the facets and CNTs, from the method for preparing a continuous CNT network film according to one embodiment of the present invention;

FIG. 4D is a schematic illustration of the gradual disappearance of the facets' morphological characteristics, from the method for preparing a continuous CNT network film according to one embodiment of the present invention;

FIG. 5A shows an SEM image of the original CNT film with a scale bar of 500 nm on the surface of copper foil, from the method for preparing a continuous CNT network film according to one embodiment of the present invention;

FIG. 5B shows an SEM image of the assembled continuous CNT network film with a scale bar of 500 nm on the surface of copper foil, from the method for preparing a continuous CNT network film according to one embodiment of the present invention;

FIG. 6A shows an optical image of free-standing, floating assembled continuous CNT network films based on a direct blade coating method with a scale bar of 2 cm, from the method for preparing a continuous CNT network film according to one embodiment of the present invention;

FIG. 6B shows an optical image of the assembled continuous CNT network films transferred to quartz substrates based on a direct blade coating method with a scale bar of 2 cm, from the method for preparing a continuous CNT network film according to one embodiment of the present invention;

FIG. 7 shows an optical image of the assembled continuous CNT network films transferred to quartz substrates with different transmittance based on a direct blade coating method with a scale bar of 2 cm, from the method for preparing a continuous CNT network film according to one embodiment of the present invention;

FIG. 8 shows the transparent conductivity performance of the assembled continuous CNT network films based on a direct blade coating method, from the method for preparing a continuous CNT network film according to one embodiment of the present invention;

FIG. 9A shows an SEM image of the original X-type loosely lapped CNTs and CNT bundles with a scale bar of 1 μm, from the method for preparing a continuous CNT network film according to one embodiment of the present invention;

FIG. 9B shows an SEM image of the assembled continuous CNT network film with a scale bar of 1 μm, from the method for preparing a continuous CNT network film according to one embodiment of the present invention;

FIG. 10 shows a set of optical images of the transfer process of a CNT film that is directly coated with the substrate removed immediately after the dispersion is dry without assembly process according to one embodiment of the present invention;

FIG. 11A shows an SEM image of a fragment sample with loosely X-type lapped CNTs and CNT bundles without being assembled into a CNT network with a scale bar of 1 μm, from the method for preparing a continuous CNT network film according to another embodiment of the present invention;

FIG. 11B shows the transparent conductivity performance of the CNT films without CNT network assembly, from the method for preparing a continuous CNT network film according to another embodiment of the present invention;

FIG. 12 shows an SEM image of an assembled continuous CNT network film based on spray coating with a scale bar of 500 nm, from the method for preparing a continuous CNT network film according to yet another embodiment of the present invention;

FIG. 13A shows an optical image of an assembled continuous CNT network film floating free-standing on ammonium persulfate with a scale bar of 2 cm, from the method for preparing a continuous CNT network film according to yet another embodiment of the present invention;

FIG. 13B shows an optical image of an assembled continuous CNT network film floating free-standing on deionized water with a scale bar of 2 cm, from the method for preparing a continuous CNT network film according to yet another embodiment of the present invention;

FIG. 14A shows an optical image of an assembled continuous CNT network film floating free-standing on deionized water with a scale bar of 5 cm, from the method for preparing a continuous CNT network film according to another embodiment of the present invention;

FIG. 14B shows an optical image of an assembled continuous CNT network film floating free-standing on deionized water with a scale bar of 10 cm, from the method for preparing a continuous CNT network film according to another embodiment of the present invention;

FIG. 15A shows an optical image of an assembled continuous CNT network-graphene film floating free-standing on deionized water with a scale bar of 2 cm, from the method for preparing a continuous CNT network film according to another embodiment of the present invention; and

FIG. 15B shows an SEM image of an assembled continuous CNT network-graphene film with a scale bar of 1 μm, from the method for preparing a continuous CNT network film according to another embodiment of the present invention

### DETAILED DESCRIPTION OF THE EMBODIMENTS

Those skilled in the art should understand that the embodiments described below represent only a portion of the invention, rather than its entirety. These embodiments are intended to elucidate the technical principles of the invention, rather than limit its scope of protection. All other embodiments that can be derived by a person with ordinary skill in the art without exerting creative effort based on those provided by the invention should fall within the scope of protection.

### Technical Problems

CNT FTCF is generally prepared through two conventional methods: one is direct growth, such as arc discharge, laser ablation, and chemical vapor deposition (CVD) methods for growth; the other is powder-based film formation, the most commonly used among the various physical and chemical methods is the solution/slurry deposition (SBD) method, which uses a CNT dispersant to form a film by coating.

However, the majority of current studies on growing carbon nanofilms using the CVD method are still in the experimental stage, focusing on small areas. Only a few studies have proposed methods for large-area fabrication. In the continuous fabrication process, the single-walled CNT flexible transparent conductive film (SWCNT-FTCF) can have unlimited length, but its width expansion is challenging due to growth principle limitations. The free-standing multi-walled CNT flexible transparent conductive film (MWCNT-FTCF) prepared through the superaligned array spinning dry process can expand in area; however, its transparency and conductivity are limited. Therefore, large-area CNT-FTCF produced by the CVD method remains impractical for widespread use.

The SBD method entails depositing a dispersion of carbon nanomaterials onto a substrate to form a film, which offers greater scalability to larger areas compared to the CVD method, thereby leading to conspicuous cost reductions. However, the SBD method also presents several limitations in producing FTCF: (1) Most films based on SBD are directly deposited onto a polymer substrate, posing challenges for subsequent steps like transfer, post-processing, etc., thereby limiting their transparency, conductivity, and application scenarios. (2) The loose X-type lap between CNTs results in weaker interactions. Although transfer without assistance can be achieved on substrates such as quartz and silicon wafers, a thicker layer is required. When the thickness is below 200 nm, SBD methods generally fail to achieve free-standing capability, leading to damage. Several filtration methods can allow films to be free-standing on water with a thickness of less than 200 nm by leveraging capillary force. However, the area is constrained by the filter membrane and filtration apparatus, and precise design of pore size and permeability for both the filtration material and dispersed liquid is necessary, making the process highly complex and limiting its scope of application. In some cases, polymer materials are introduced as additives, adhesives or a phase of composite to facilitate peeling or transfer, which conspicuously enhances sheet resistance and constraining the range of applications. Currently, large-scale production of high-quality TCFs with thicknesses less than 200 nm using SBD methods remains a major challenge. (3) Due to the high thickness of TCF produced by the SBD method, its transparency is often limited to 70%-80%. Some research work used the SBD method to directly dry the dispersion liquid on a transparent substrate and form a film, avoiding the transfer process, to obtain a thinner thickness and up to 90% transmittance. However, the CNT-FTCF produced by this method also faces the problem of loose lap and weak interaction between CNTs, resulting in a large resistance. Moreover, the CNTs in the CNT-FTCF produced by the SBD method are often isolated and loosely stacked in a disordered manner, making it difficult to form efficient conductive paths, so the overall sheet resistance is higher, often exceeding 1000Ω/□, even tens of thousands. To address this issue, it is often necessary to employ post-processing techniques such as chemical doping (HNO₃, AuCl₃, TFSA, etc.) to enhance conductivity. However, these methods not only introduce additional elements into the CNT FTCF but also encounter challenges related to poor stability, high cost, and complex processes. Furthermore, most dopants lead to reduced transmittance and increased areal density. (4) In order to enhance the physical properties of CNT films produced by the SBD method, post-processing methods for CNT FTCF primarily focus on improving the intrinsic properties of CNTs. However, there is a notable lack of approaches aimed at enhancing the film structure, resulting in challenges in establishing effective connections between loosely X-type lapped CNTs and leaving them relatively independent. Some efforts have been made to address this issue through welding techniques, such as laser welding, which can be cost-prohibitive.

Therefore, this invention proposes a method for preparing a continuous CNT network film, which can connect and assemble the loose X-type lapped and relatively independent CNT powder into a continuous network structure, thereby achieving improved transparency, conductivity, mechanical properties, and realizing free-standing capability, meanwhile enabling the mass production of area-unlimited assembled continuous CNT network films.

### The Solution to Technical Problems

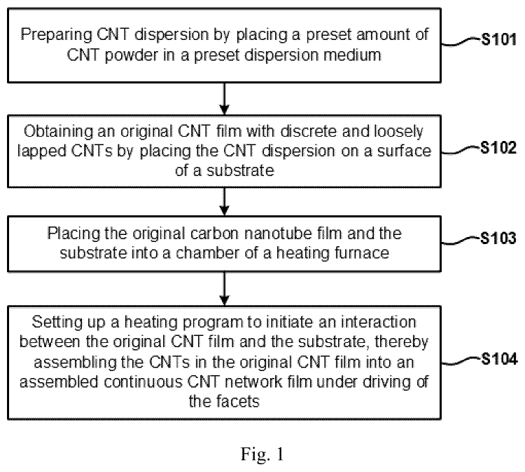

FIG. 1 is a flowchart outlining the process for preparing a continuous CNT network film in accordance with one embodiment of the present invention, in this embodiment, the process may generally include:

Step S101, preparing CNT dispersion by placing a preset amount of CNT powder in a preset dispersion medium. In some optional embodiments, CNT powder is a powdered substance consisting of a large number of CNTs, which has a series of excellent physical, chemical, and mechanical properties. The CNTs in the CNT powder comprise a mixture of any one, or any combination of the following: single-walled, double-walled, few-walled, and multi-walled CNTs. In the case where the transparency of the target product is equal to or greater than 80%, a more preferred option for the specific material of the CNT powder can be single-walled CNTs, multi-walled CNTs, or a mixture of single-walled and multi-walled CNTs. If the transparency of the target product is less than 80%, any of the CNTs or a combination thereof from the aforementioned embodiment can be chosen.

The predetermined dispersion materials include atmospheric dispersion, dispersion in liquids, and spreading of CNT powders. An example of a preferred implementation is the predetermined dispersion material is determined to be a dispersion in liquids, thus a predetermined amount of CNT powder is placed in the predetermined dispersant. The steps to obtain a CNT dispersion can typically include: placing a predetermined amount of CNT powder in a CNT dispersion liquid, adding a surfactant, and dispersing the CNT powder through a predetermined dispersing method to uniformly disperse the CNT powder in the CNT dispersion liquid. Optionally, the dispersant used in the CNT dispersion solution typically consists of water, ethanol, N-methyl pyrrolidone (NMP), N, N-dimethylformamide (DMF), butyl acetate, isopropanol, methyl methacrylate (PMA), N, N-dimethylacetamide (DMAC), or any combination thereof. The preset dispersing method generally includes any of the following: shaking, stirring, or ultrasonic dispersion.

In the process of preparing CNT dispersion, it is necessary to ensure that the density of the CNT dispersion (the number or mass per unit area) is sufficient to meet the consumption of CNTs in forming a continuous Y-type interconnected network on the facets, and also to meet the requirement of driving CNTs to form complete pores and a continuous network, avoiding the formation of non-continuous networks or incomplete pores. Optionally, the density of the CNT dispersion is greater than a predetermined density, so that the sheet resistance of the CNT dispersion on the surface of the substrate is less than 10,000Ω/□. In some preferred embodiments, the sheet resistance of the CNT dispersion on the surface of the substrate can be less than 5,000 Ω/□.

It should be noted that the various optional items listed in the above embodiment of the present invention are preferred solutions, and those skilled in the art can choose the above examples and other items not listed as needed to obtain a dispersion of CNTs.

Step S102, obtaining an original CNT film with discrete and loosely lapped CNTs by placing the CNT dispersion on a surface of a substrate. In some optional embodiments, the original CNT film is formed by loose X-type lap of individual CNTs and bundles, and the lap of the individual CNTs and the bundles of CNTs is generally in the form of X-type, i.e., multiple individual CNTs and bundles are loosely lapped with each other by crossing over each other to form the original CNT film.

Optionally, the substrate material may generally include, but is not limited to, metals, semiconductors, and other compounds, of which metals may generally include: copper, platinum, gold, nickel, titanium, iron, lead, palladium, silver, tungsten, aluminum, zinc, chromium gold, and alloys of several metals; Semiconductors can generally include: silicon, germanium, gallium arsenide, gallium nitride, indium phosphide, titanium oxide, alumina, iron sulfide, nickel sulfide, cadmium selenide, etc.; Other compounds can generally include vanadium oxide, manganese oxide, silicon oxide, etc. Among the preferred options, the material of the substrate can be copper, platinum, gold, nickel, titanium, iron, lead, palladium, silver, tungsten, aluminum, zinc, chromium, or any combination of any of the above metals or alloys of two or more of the above metals. Those skilled in the art can select the suitable substrate material according to the actual production needs.

Optionally, the methods of placing the CNT dispersion on the surface of the substrate may generally include, but are not limited to, simple placement, powder dipping, or supplemented with organic solvent treatment, as well as any or any combination of fluidized-bed vapor deposition, powder coating, powder vapor spraying, coating, blade coating, spraying, drip coating, centrifugal film preparation. Preferably, after the CNT dispersion is placed on the surface of the substrate, a pre-set film-forming method can be used, which can be a combination of any one or more of the following methods: natural drying, blowing, thermal evaporation, and vacuum drying, to better form the CNT dispersion.

It should be noted that the aforementioned examples are purely optional, and the selection of placement or coating methods should not be limited to those provided. Those skilled in the art can choose suitable placement methods and corresponding preset coating methods according to actual circumstances.

In some optional embodiments, the step of placing the CNT dispersion on the surface of the substrate may also generally be preceded by: pretreatment of the substrate to make the surface of the substrate flat; pretreatment methods include mechanical polishing, electrochemical polishing, high-temperature annealing or any combination of the above methods. Those skilled in the art can determine the pretreatment method of the substrate according to the actual situation.

Step S103, placing the original CNT film and the substrate into a chamber of a heating furnace.

Step S104, setting up a heating program to initiate an interaction between the original CNT film and the substrate, thereby assembling the CNTs in the original CNT film into an assembled continuous CNT network film under driving of the facets.

In some optional embodiments, the steps for the interaction between the original CNT film and the substrate generally include: the substrate undergoes surface reconstruction with the gas in the chamber of the heating furnace, accompanied by the transport of atoms constituting facets, showing regular stepped or zigzag structures on the surface of the substrate at the mesoscopic scale; the facets interact with the original CNT film to eliminate impurities, at least a portion of the CNTs in the original film are compelled by the facets to relocate, causing adjacent CNTs or bundles to come into close proximity, which facilitates the assembly of CNTs, thus obtaining the assembled continuous CNT film. In this process, under driving of the facets, more and more CNTs in the original CNT film adhere tightly to the facets and then undergo obvious movement. The majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. For some short CNTs, under the influence of driving of the facets, they gather at the grooves and depressions formed at the facet steps, and adjacent short CNTs or CNT bundles tend to converge towards each other, forming bundles of larger diameter constrained by van der Waals forces. With an appropriate CNT density, the larger-diameter bundles converge and form long bundles, encircling the facet steps. The long bundles form a common segment at where they gather and a pore at where they separate. The facets are in close proximity to one another, causing the pores to be adjacent to each other, making the adjacent long bundles form Y-type connections, thereby forming a continuous Y-type interconnected network. It should be noted that the material of the substrate in the method of the present invention is not limited, and the corresponding reaction gas can be selected according to the material of the substrate, so that the surface of the substrate undergoes reconstruction and forms facets.

Optionally, the gas is capable of undergoing surface reconstruction with the substrate in the chamber of the heating furnace, comprising any one, or any combination of homologous gases in either oxidizing or reducing gas types. Homologous gases refer to gases with similar chemical properties, such as selecting multiple homologous gases in oxidizing gases, such as oxygen, chlorine, and bromine. Gas sources may consist of gas, liquid, solid forms, or any combination thereof. Those skilled in the art can select the appropriate gas that undergoes surface reconstruction with the substrate based on the actual material and structure of the substrate.

The substrate undergoes surface reconstruction with the gas in the chamber of the heating furnace, forming facets, which typically includes the following steps: purging the chamber of the furnace to control the partial pressure of the gas that undergoes surface reconstruction with the substrate in the chamber, and keeping it within a predetermined range; heating the chamber to promote surface reconstruction between the surface of the substrate and the gas, forming facets. In some optional embodiments of the present invention, wherein purging is the process of removing impurities from the mixed gas, the gas used in the purging process generally includes any one of nitrogen, argon, and hydrogen gas or a mixture of the gases. Those skilled in the art can determine the specific gas type used for purging based on the actual situation. When the substrate material is chosen as metal or alloy, an oxidizing gas is generally selected for the gas that undergoes surface reconstruction with the substrate. Preferably, when the substrate material is copper, an oxidizing gas such as oxygen is preferred in the chamber of the heating furnace of the present invention. In this case, the partial pressure of the gas in the chamber of the heating furnace can be referred to as the oxygen partial pressure. The oxygen partial pressure refers to the partial pressure of oxygen in a gas mixture, and is a measure of the concentration of oxygen. It reflects the pressure of oxygen in the gas mixture, and is usually expressed in millimeters of mercury (Torr) or kilopascals (kPa). The oxygen partial pressure required for the substrate to form facets with oxygen reacts differently depending on the material of the substrate, and optionally, the range of oxygen partial pressure for different substrates can generally be set to ≤1 Torr, 1-10 Torr, and ≥10 Torr. Those skilled in the art can choose a substrate that will form facets under specific conditions and interact with the reactants, based on the desired end product. The corresponding gas partial pressure of the substrate can be adjusted within a specified range. In principle, there are no strict limitations on the thickness, rigidity, or flexibility of the substrate. In some optional embodiments, considering that a flexible substrate is often required in the confined growth space of the chamber of the heating furnace, i.e., growth zone, an ideal example of a substrate would be a foil-type.

When the substrate is determined and the oxygen partial pressure in the chamber of the heating furnace is controlled within a predetermined range, the chamber needs to be heated to control the oxygen adsorbed on the surface of the substrate and the substrate to undergo surface reconstruction, forming facets. Subsequently, the facets interact with the original CNT film to complete the assembly process of the continuous CNT network. The specific temperature values will vary depending on the substrate material. Let T₁ denote the temperature at which the facets begin to appear on the selected substrate.

Optionally, the steps of initiating the interaction between the facets and the original CNT film typically involve: When Tₓ=T₁, as atoms or molecules constituting facets on the surface of the substrate undergo transport, the interaction between the facets and the original CNT film commences. Due to the limited size of the facets at this stage, the overall probability of transported atoms or molecules interacting with the original CNT film is relatively low, rendering this interaction inconspicuous. Consequently, when Tₓ=T₁, the assembly process remains inconspicuous or incomplete, and the CNTs within the original CNT film have yet to form common segments and network structures. At this stage, the CNTs in the original film are randomly and disorderly distributed and overlapped. The spaces between them are not continuous pores formed by a network structure, but rather random and minute gaps, even with impurities. Consequently, these characteristics prevent the attainment of desirable physical properties such as high light transmittance and robust mechanical performance. As the temperature continues to rise, i.e., Tₓ>T₁, the facets progressively increase in size, with their boundaries expanding. This expansion leads to the gradual convergence of boundaries between some or even most adjacent facets, resulting in the formation of distinct stepped or zigzag morphologies on the surface of the substrate. During the progressive growth of the facets, accompanied by the transport of atoms or molecules constituting facets, at least a portion of the CNTs in the original CNT film gradually adhere to the facets. As the facets grow, their boundaries expand and gradually converge until they eventually come into contact. The CNTs adhering to the facets, along with impurities in the original CNT film, are compelled to relocate by the expanding facet boundaries. This interaction between the facets and the CNTs results in the migration of some CNTs to the contact areas between the facets, leading to the initial formation of a common segment of CNTs. Impurities move during the growth of facets, shortening the distance from the facets and facilitating the interaction between them. In this case, spaces between the CNTs expand resulted by the movement of CNTs and impurities, as well as the initial formation of common segments, thereby forming sporadically distributed individual or a few consecutive small pores that are small in size and limited in number.

When Tₓ≥T_{L}, a portion of the impurities gradually interact with the facets. Therefore, during this process, the areal density of the film initially decreases. As the temperature continues to increase, specifically when Tₓ>>T₁, the assembly process becomes increasingly conspicuous. This is manifested by the expansion of facet edges during heating, leading to increased contact areas between them. Under driving of the facets, some CNTs in the original CNT film gradually adhere to the facets, subsequently moving and assembling to form extended common segments at the areas of contact. At this stage, with Tₓ>T_{L}, the facets continuously dissolve impurities adhering to them, including defective CNTs, weak or thin CNTs, catalyst particles, and amorphous carbon, thereby facilitating the assembly of a portion of fresh Y-type interconnected continuous network with a long common segment.

When the temperature Tₓ continues to rise from T₁ to T₂ (the temperature at which the facets start to grow conspicuously, the grooves and depressions between the facets further expand, eventually forming regular and well-aligned stepped or zigzag morphologies), the growth rate of the facets transitions from gradual to rapid and the edges of the facets contact with each other after expansion. As the contact areas continue to increase, the grooves and depressions between the facets form and eventually result in regular and well-aligned stepped or zigzag morphologies. During this process, the interactions between the original CNT film (containing impurities) and the facets become more conspicuous. The CNTs, along with their impurities, move and approach the facets under driving of the facets (that is, the transport of a large number of atoms or molecules constituting the facets causes the CNTs containing impurities to move). In this period, spaces between CNTs further expand. The pores begin to transition from sporadic distribution to many interconnected networks within localized regions, promoted by CNT movement, impurity elimination, and the initial formation of continuous network as the facets grow up. Therefore, at Tₓ=T₂, it is essential to maintain the temperature for a certain duration to ensure that the facet growth process has adequate time to proceed, meanwhile allowing the conspicuous interactions to persist for a sufficient period, thereby ensuring their completion to a greater extent.

The assembly process is conspicuous, manifested as follows: Under driving of the facets, more and more CNTs in the original CNT film adhere tightly to the facets and then undergo obvious movement. The majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. For some short CNTs, under the influence of driving of the facets, they gather at the grooves and depressions formed at the facet steps, and adjacent short CNTs or CNT bundles tend to converge towards each other, forming bundles of larger diameter constrained by van der Waals forces. With an appropriate CNT density, the larger-diameter bundles converge and form long bundles, encircling the facet steps. The long bundles form common segments at where they gather and pores at where they separate. The facets are in close proximity to one another, causing the pores to be adjacent to each other, making the adjacent long bundles form Y-type connections, thereby forming a continuous Y-type interconnected network. By conducting a conspicuous assembly process at a constant temperature of Tₓ=T₂ for a certain duration, the original CNT film forms a large-area, Y-type interconnected network with a long common segment through the interaction between facets and the CNTs along with impurities within it. At this stage, a fully assembled CNT network has already formed. Consequently, the many small networks within localized regions evolve to extensively connected networks, eventually forming one fully interconnected network as the assembly process under driving of the facets proceeds in the isothermal duration. Since the pore boundaries in an assembled network arc formed by either long common CNT segments and CNT Y-type connections in facet grooves and depressions or CNT bundles crossing several facets, or a combination of both, combined with the regulating conditions including the original CNT density and the assembly duration, their sizes are related to their possible geometries: narrow elongated pores matching single facet step dimensions and wider expanded pores crossing multiple facet steps.

When the temperature increases to T₂, where typically T₂>T_{L}, under this condition, the intense transport of a substantial number of atoms or molecules constituting facets effectively removes the impurities in the original CNT film, further decreasing its areal density. Since the defective CNTs and bundles in the original CNTs are effectively eliminated owning to the tight adhesion to the facets resulted by driving of the facets, the pore diameters (also known as pore size) of the assembled network change. Meanwhile, with their boundaries mostly formed by long common CNT segments and CNT Y-type connections converging in facet grooves and depressions, the pores generally align along the edges of the facet steps, which means the pore size is constrained by driving of the facets as the facets grow and contact each other. Consequently, except for a few pore diameters that do not change conspicuously, most pore diameters become larger or smaller to a certain extent due to impurity elimination and facet constraints. Therefore, under the dual effect of eliminating impurities of various types (including dispersants, stabilizers, additives and other organic impurities from the raw materials, trace amounts of metals or inorganic salts, defective CNTs and bundles, thin and weak CNTs, catalyst particles and amorphous carbon within the CNTs) and facet boundary constraints, both of which are resulted from driving of the facets, the network structure of the assembled continuous CNT network film is optimized, and the pore diameter becomes more uniform. Optionally, the temperature range in which facets grow and drive CNT networks to adhere tightly to the facets and assemble into a network can generally be set to be greater than T₂.

Preferably, the interaction process between the facets and the original CNT film also involves the following: as the temperature Tₓ increases from T₂ to T₃ (the temperature at which the selected surface of the substrate begins to melt), the morphological characteristics of the facets start to diminish. When the heating temperature Tₓ≥T₃, which marks the temperature range wherein the morphological characteristics of the facets progressively diminish, the assembly process of the CNT network is essentially complete. During this process, as T₃ approaches or reaches the substrate's melting point, the pre-melting of the surface of the substrate becomes increasingly conspicuous, and the atomic or molecular transport at the facets intensifies. Residual impurities in the already formed CNT network, such as catalyst particles, defects, and weak CNTs, are further eliminated. This removal process intertwines with the earlier impurity elimination processes, ultimately preserving the assembled CNT network structure while almost completely eliminating impurities, thus enhancing pore size uniformity, and reducing the film's areal density. Consequently, a whole and completely assembled continuous CNT network film is obtained. An example of the temperature range wherein the morphological characteristics of the facets progressively diminish is defined as being greater than or equal to T₃.

It should be noted that the situation in which the original CNT film is placed on the surface of the substrate exhibits regional variations at both microscopic and mesoscopic scales, leading to differing interaction processes. Consequently, the aforementioned three steps may occur separately, concurrently, or in an intertwined manner under specific conditions during the entire interaction process between the facets and the original CNT film.

Those skilled in the art can ascertain the precise values of the aforementioned temperature ranges and the specific temperature ranges corresponding to various operations based on the actual material properties of the substrate.

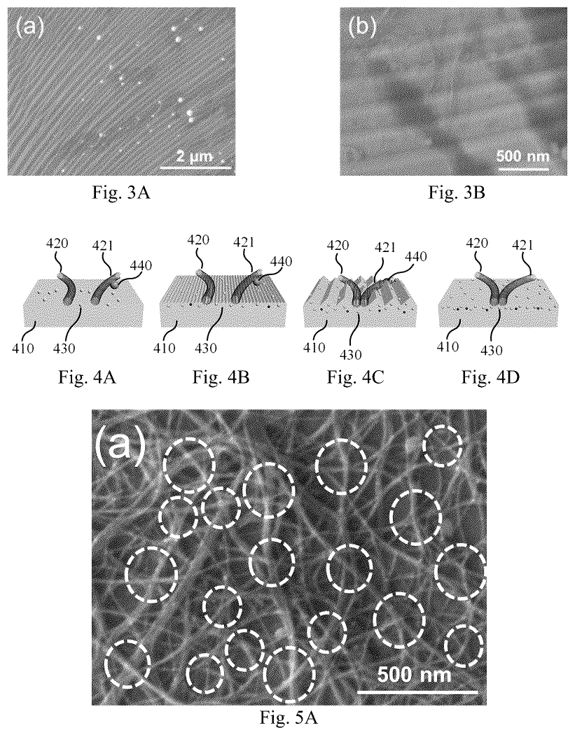

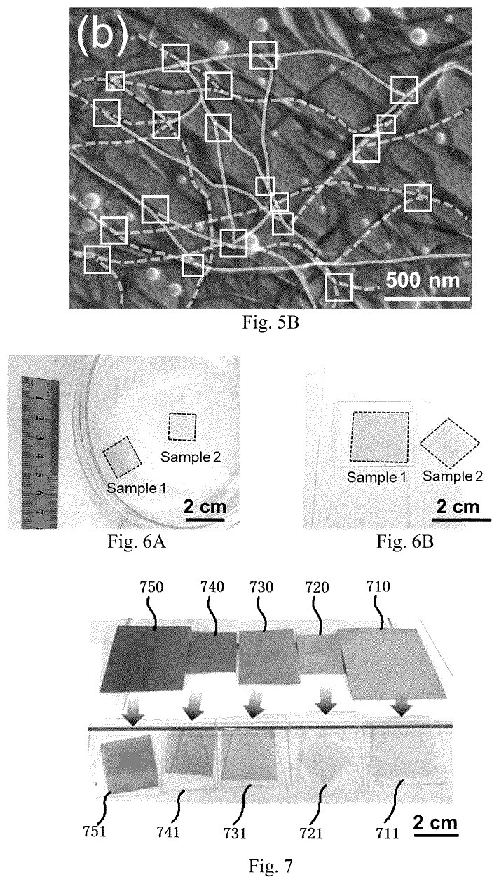

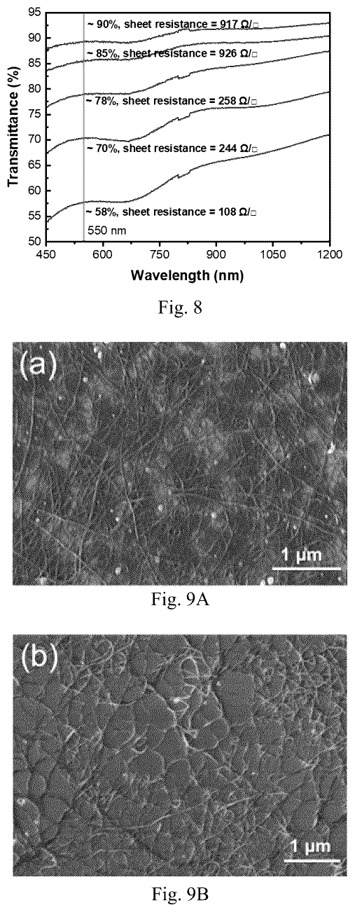

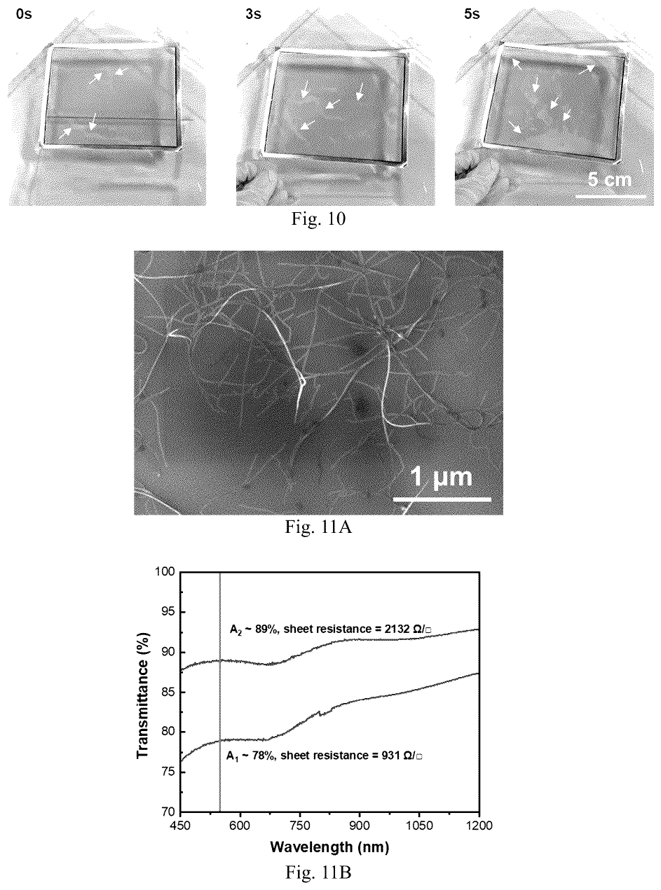

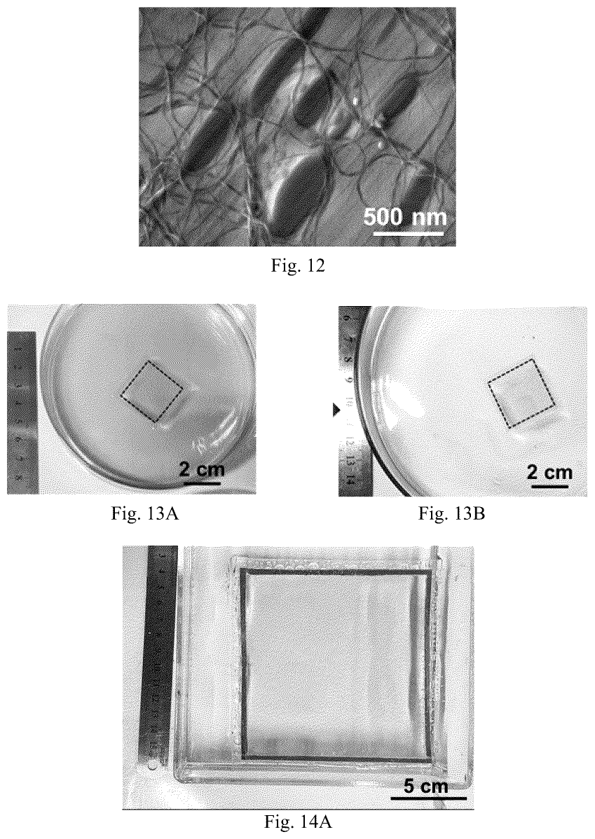

In this process, an optional example of the substrate facets is shown in FIG. 3. FIG. 3A shows an SEM image of a copper facets on surface, and FIG. 3B shows an SEM image of a copper facets on surface, both from the method for preparing a continuous CNT network film according to one embodiment of the present invention. FIG. 3A and FIG. 3B both show the SEM images of copper facets obtained by heating copper at 10° C./min to 900° C. at 10⁻² Torr oxygen partial pressure after rapid cooling.

Optionally, the schematic diagram of the assembly for the original CNT film under driving of the facets is shown in FIG. 4: FIG. 4A is a schematic illustration of the beginning of the facet growth, FIG. 4B is a schematic illustration of the progressive development of the facets, FIG. 4C is a schematic illustration of the interaction between the facets and CNTs, and FIG. 4D is a schematic illustration of the gradual disappearance of the facets' morphological characteristics, all from the method for preparing a continuous CNT network film according to one embodiment of the present invention. When the heating temperature reaches T₁, the substrate 410 initiates facet growth, during which time CNTs 420 and 421, oxygen 430, and impurities 440 are all present on surface of the substrate 410, as depicted in FIG. 4A. As the temperature increases, conspicuous facets emerge on the surface of the substrate, and some impurities begin to dissolve. With further increase in temperature, the facets gradually expand, as illustrated in FIG. 4B. When the heating temperature reaches T₂, the step width of facets continues to increase to approximately 100 nm, signifying a conspicuous interaction between the CNTs and the facets. The CNTs tightly adheres to the surface of the substrate, and as the facets grow, they undergo substantial movement, as depicted in FIG. 4C. As the temperature reaches T₃, which approaches the melting point of the substrate, the facets gradually diminish with the assembled continuous CNT network formed and preserved, and impurities 440 eliminated, as illustrated in FIG. 4D.

Ultimately, the structure of the original CNT film and the structure of the assembled continuous CNT network film are compared as shown in FIG. 5. FIG. 5A shows an SEM image of the original CNT film on the surface of copper foil, the dashed rectangle indicates the loose X-type lap of the original CNTs, while FIG. 5B shows an SEM image of the assembled continuous CNT network film on the surface of copper foil, both from the method for preparing a continuous CNT network film according to one embodiment of the present invention. FIG. 5B shows the SEM image of the assembled continuous CNT network film/copper foil heated to 900° C. under a 10⁻² Torr oxygen partial pressure and rapidly cooled. The conspicuous regular stepped pattern reveals the formation of facets with sizes of approximately 200 nm, while the assembled CNT network exhibits pore sizes in the range of several hundred of nanometers. As shown in the comparison between FIG. 5A and FIG. 5B, the original CNTs with loose X-type lap are assembled into a continuous network after the treatment by this method. The dotted and solid lines indicate the tendency of different CNTs or bundles to form a Y-type interconnected network with a long common segment under driving of the facets, and the boxes indicate the intersection points where CNTs or bundles form large numbers of Y-type junctions in the Y-type interconnected network with a long common segment under driving of the facets.

Through this method, the assembled continuous CNT network film functions as a CNT flexible transparent conductive film (CNT FTCF), with the loose X-type lap of CNTs being assembled into a continuous network under driving of the facets. This structural optimization enhances the transparency, conductivity, and mechanical properties of CNT FTCF synergistically. Furthermore, this scalable method involves placing CNT powder on a substrate to obtain original CNT and CNT bundles in a loose X-type lapped and disordered structure without restrictions on substrate area size, enabling large-scale and mass production of CNT FTCF with unlimited lengths and widths.

Optionally, the step of placing the CNT dispersion on the surface of the substrate may further include: dropping a volatile organic solvent onto the original CNT film to wet the original CNT film, thereby increasing the degree of contact between the loose CNTs and the surface of the substrate; after the organic solvent has evaporated, the step of placing the original CNT film and the substrate into a chamber of a heating furnace is performed. The method is not limited to the type of organic solvent, and a preferred example is that the organic solvent may include ethanol, propanol, butanol, ethylene glycol, isopropanol, acetone, n-hexane, cyclohexane, benzaldehyde, chlorobenzene. Those skilled in the art can select the corresponding organic solvent according to actual conditions.

Optionally, the step following the interaction of the facets with the original CNT film may typically involve: cooling the assembled continuous CNT network film according to a predetermined cooling rate; etching the substrate from the cooled assembled continuous CNT network film by placing them in a substrate etching agent and washing it with a rinsing liquid. The substrate etching agent can be determined according to the substrate material and structure; in some embodiments of the invention, substrate etches may generally include any one of the following solutions: ammonium persulfate solution, ferric chloride solution, hydrochloric acid solution, hydrochloric acid mixed with hydrogen peroxide solution. Those skilled in the art can select the appropriate etchant for the substrate based on specific circumstances. Some optional examples of predetermined cooling rates are as follows: <10° C./min, 10-100° C./min, >100° C./min, with the preferred option being 100° C./min. In some optional embodiments, the rinse solution is selected based on the etchant used for the substrate. Preferably, deionized water is used as the rinse solution. Those skilled in the art can select the rinse solution based on actual conditions. Optionally, the step of rinsing can generally include: using a preferred deionized water for rinsing. After rinsing with deionized water, a free-standing on the surface of water, large-area, whole and completely assembled carbon continuous nanotube network film can be obtained without the need for polymer-assisted transfer, and can also be free-standing in air. The free-standing assembled continuous CNT network films can also be transferred to any substrate without damage.

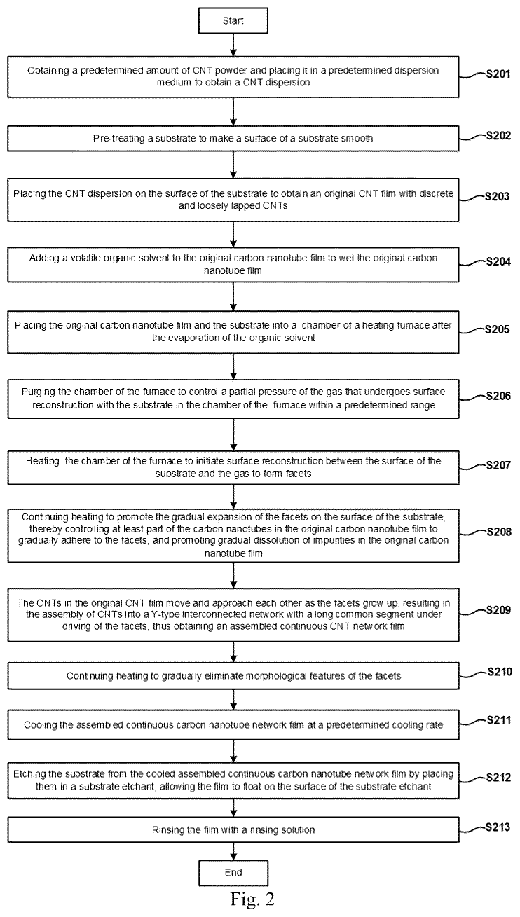

FIG. 2 is a flowchart outlining the process for preparing a continuous CNT network film in accordance with another embodiment of the present invention; In some optional embodiments, the process may generally include:

Step S201, obtaining a predetermined amount of CNT powder and placing it in a predetermined dispersion medium to obtain a CNT dispersion.

Step S202, pre-treating a substrate to make a surface of a substrate smooth.

Step S203, placing the CNT dispersion on the surface of the substrate to obtain an original CNT film with discrete and loosely lapped CNTs.

Step S204, adding a volatile organic solvent to the original CNT film to wet the original CNT film.

Step S205, placing the original CNT film and the substrate into a chamber of a heating furnace after the evaporation of the organic solvent.

Step S206, purging the chamber of the furnace to control a partial pressure of the gas that undergoes surface reconstruction with the substrate in the chamber of the furnace within a predetermined range.

Step S207, heating the chamber of the furnace to initiate surface reconstruction between the surface of the substrate and the gas to form facets.

Step S208, continuing heating to promote gradual expansion of the facets on the surface of the substrate, thereby controlling at least a portion of the CNTs in the original CNT film to gradually adhere to the facets, and promoting gradual dissolution of impurities in the original CNT film.

Step S209, the CNTs in the original CNT film move and approach each other as the facets grow up, resulting in the assembly of CNTs into a Y-type interconnected network with a long common segment under driving of the facets, thus obtaining an assembled continuous CNT network film.

Step S210, continuing heating to gradually eliminate morphological features of the facets.

Step S211, cooling the assembled continuous CNT network film at a predetermined cooling rate.

Step S212, etching the substrate from the cooled assembled continuous CNT network film by placing them in a substrate etchant, allowing the film to float on surface of the substrate etchant.

Step S213, rinsing the film with a rinsing solution.

The assembled continuous CNT network film obtained by this method, also referred to as “assembled CNT FTCF” in the present invention, can optimize the network structure from the microscopic level by driving the loose X-type lapped CNTs to assemble into a whole and continuous network. This can enhance the transparency, conductivity, and mechanical properties of CNT FTCF synergistically; this approach uses a method of placing CNT powder on a substrate to obtain an initial structure of loose X-type lapped CNTs and CNT bundles, with the substrate area being unlimited, and is scalable, allowing for the production of CNT FTCF with lengths and widths that are not limited, thus enabling large-scale and mass production.

### Advantageous Effects of Present Invention

The subsequent section provides a detailed account of the advantageous effects of the continuous CNT network film prepared using this method.

1. Effectively assembling loose X-type lapped CNT powder into a Y-type tightly interconnected continuous CNT network, thus obtaining the assembled CNT TCFT with a continuous network.

The method of powder-based film formation has the potential for mass production and large-area production. However, after the CNT powder dispersion forms a film, the physical contact between CNTs is often limited to loose X-type lap due to small capillary forces during solvent evaporation in SBD-based processes, resulting in weak interactions. Consequently, the final structure of the CNT film is loose with poor mechanical properties and difficulty in transferability, manifested by their failure in maintaining structural integrity independently without the support of a solid-phase substrate, i.e., failure in being free-standing. Generally, transferring CNT films based on SBD processes requires solid assistance such as polymers. Although transfer without assistance can be achieved on substrates such as quartz and silicon wafers, a thicker layer is required. When the thickness is below 200 nm, SBD methods generally fail to achieve free-standing capability, leading to damage, while when the thickness is above 200 nm, its transparency is greatly reduced, generally below 50%, limiting its application scenarios. Several filtration methods can allow films to be free-standing on water with a thickness of less than 200 nm by leveraging capillary force. However, the area is constrained by the filter membrane and filtration apparatus, and precise design of pore size and permeability for both the filtration material and dispersed liquid is necessary, making the process highly complex, which leads to small area coverage, high time cost, difficulty in expansion, and limited application scenarios. In some other cases, polymer materials are introduced as additives, adhesives or a phase of composite to facilitate peeling or transfer, which conspicuously enhances sheet resistance and constraining the range of applications. The above methods can only connect specific CNT dispersions with loose X-type laps, to some extent enhancing the simple contact between CNTs, but cannot assemble the loose CNT powder into a high-quality continuous network.

In the present invention, CNTs move under driving of the facets, and the CNTs and CNT bundles, which are originally discrete and loosely X-type lapped, are therefore constrained by the facets to form a continuous network:
under the driving force of facets, the discrete short CNTs in the original CNT film gather at the step, and adjacent short CNTs or CNT bundles tend to be close together, forming bundles of larger diameter constrained by van der Waals forces. When the CNT density is suitable, the larger diameter bundles adjacent to the step interlock with each other to form long bundles, wrapping around the facet step. The longer bundles gather to form pores, and the facets are closely spaced, causing the adjacent pores to be adjacent to each other, causing the adjacent longer bundles to form Y-type connections, thereby forming a continuous Y-type interconnected network with the pores evenly spaced, thus assembling the CNTs in the original CNT film to form the assembled continuous CNT network film. Thus, CNTs and CNT bundles transition from a state of dispersion, looseness, and weak interaction to a tightly interconnected continuous network structure, resulting in conspicuous enhancements in mechanical properties. They can be transferred at a thickness of less than 200 nm without the need for support or area limitation, and without requiring additional additives or complex processes. It should be noted that the “discrete” state described in this invention includes the physical direct contact between CNTs and CNT bundles in the coating means of the aforementioned other methods and the precoating method in this method (including but not limited to simple stacking, lapping, and close proximity without forming van der Waals force constraints or bonds), as well as the discrete state that does not have physical contact but meets the predefined conditions for dispersed materials in this invention. The key distinction of this method from others lies in its ability to assemble loosely X-type lapped CNT powder (the discrete CNTs) into a continuous network through assembly under driving of the facets, obtaining a CNT FTCF with a tight continuous Y-type network with strong interaction.

2. The CNT powder form a continuous network under driving of the facets, and various properties (transparent conductivity, mechanical properties) of the assembled network are synergistically improved.

The process of assembly of CNTs and CNT bundles under driving of the facets into a tight network promotes CNTs to form a more efficient conductive network with uniform and extensively interconnected pores, resulting in a conspicuous synergistic enhancement of the sheet resistance and transmittance of CNT FTCF. The continuous CNT network film prepared by this method achieves a transmittance of ˜90% without doping or post-processing while reducing the sheet resistance to less than 1000Ω/□. By utilizing CNT dispersions with higher quality (such as longer single-walled CNTs and improved dispersants) to effectively reduce the sheet resistance of the original CNT film, or performing appropriate treatment on the substrate (e.g., annealing or monocrystallization) to further regulate the facet structure, the transparency and conductivity of the resultant continuous CNT network film will be conspicuously enhanced, thus obtaining low areal density (<2 μg/cm²) large-area, free-standing assembled CNT FTCFs with transmittance exceeding 90% and sheet resistance below 100Ω/□ as well as transparent conductive films based on it, which can meet the industrial standards including touch screen (transmittance >85% and sheet resistance <500Ω/□) and liquid crystal display (transmittance >85% and sheet resistance <100Ω/□).

There exists a trade-off between high transparency, conductivity, and mechanical properties in CNT FTCTs fabricated from CNT powder. The method of forming a film based on CNT powder (mainly SBD method) often results in disconnected, loose and disordered X-type junction CNTs or CNT bundles, which cannot form an effective conductive network due to the percolation effect, and require a very high sheet resistance (>10000Ω/□) to achieve high transparency. To improve the physical properties of CNT films, the post-treatment methods for CNT FTCF produced by the SBD method mainly focus on enhancing the properties of CNTs themselves, with a serious lack of means to improve the structure. It is difficult to form effective connections between the loose X-type lapped CNTs, leaving the CNTs in a relatively isolated state. Some works have utilized welding methods, such as laser welding, to achieve the overlapping of CNTs and form a continuous network, but the cost is extremely high. The present invention assembles the CNT FTCF network structure through the driving of the facets, breaking the limitation that the transparency and conductivity of the FTCF are mutually restrained. This synergistic enhancement of transparent conductivity and flexibility in assembling CNT continuous network film in the field of flexible electronics and optoelectronic device manufacturing has important application value.

Due to the high thickness of TCF produced by the SBD method, its transparency is often limited to 70%-80%. Some research work used the SBD method to directly dry the dispersion liquid on a transparent substrate and form a film, avoiding the transfer process, to obtain a thinner thickness and up to 90% transmittance. However, the CNT-FTCF produced by this method also faces the problem of loose lap and weak interaction between CNTs, resulting in a large resistance. Moreover, the CNTs in the CNT-FTCF produced by the SBD method are often isolated and loosely stacked in a disordered manner, making it difficult to form efficient conductive paths, so the overall sheet resistance is higher, often exceeding 1000Ω/□, even tens of thousands. To address this issue, it is often necessary to employ post-processing techniques such as chemical doping (HNO₃, AuCl₃, TFSA, etc.) to enhance conductivity. However, these methods not only introduce additional elements into the CNT FTCF but also encounter challenges related to poor stability, high cost, and complex processes. Furthermore, most dopants lead to reduced transmittance and increased areal density. Compared to post-processing methods such as chemical doping and metal deposition, the method of assembling CNT networks offers several advantages: (1) No other elements are introduced, which does not increase the areal density of CNT FTCF and does not limit its application scenarios. (2) The conductive type of CNT FTCF is not changed (semiconductor/metallic), maintaining its most intrinsic properties. (3) The problem of degradation, volatilization, hydrolysis, and corrosion of doping agents is avoided, ensuring the long-term stability of CNT FTCF. (4) The problems of expensive doping agents and complex deposition processes are avoided, making it a simple and economical method.

In the present invention, the assembled continuous CNT network film, including those with light transmittance higher than 80%, can be free-standing and transferred to other substrates by virtue of the continuous network with interconnected pores. In contrast, the loose powder with the same transmittance cannot be free-standing and may disintegrate, agglomerate, or disperse directly on the surface of liquid, or break or crumble during substrate etching or transfer processes. In this invention, the assembled continuous CNT network film forms tight network connections by assembly under driving of the facets. The loose X-type lapped and discrete CNTs are transformed into more tightly bundled CNTs and the Y-type interconnected network with a longer common segment, which is a more rigid continuous network structure with higher mechanical performance. Not only does it have good flexibility, but it can also be free-standing on the surface of liquid, even in the air.

Therefore, the present invention can transfer the CNT powder into a continuous network under driving of the facets, improving various properties synergistically.

3. Establishing a platform for the processing and post-processing of CNT FTCFs produced through the CNT powder-based film formation methods, thereby expanding its range of potential applications.

Most of the methods for forming CNT FTCF films based on CNT powder (such as the SBD method) involve directly placing CNTs on a polymer substrate. In this process, the interaction force between CNTs and the substrate is often stronger than that between CNTs themselves, making it challenging to transfer the film. Furthermore, the polymer substrate is not resistant to high temperatures that are necessary in common CNT annealing, and may be damaged by chemical agents in chemical treatment methods used for CNTs, which conspicuously limits the conditions and types of post-processing steps. Films obtained through powder-based film formation often contain impurities due to different dispersants, including catalysts, dispersant particles, and amorphous carbon, which will become scattering centers that not only result in more light absorption but also affect the film conductivity. Additionally, extra metal elements can restrict the application of these films in certain special environments such as non-magnetic ones.

In this invention, the optional high-melting point substrate (e.g., copper with a melting point of 1083° C.) enables various thermal treatment methods for CNTs to be conducted in an oxygen-free atmosphere. As CNTs and CNT bundles are assembled on the surface of the substrate to form a continuous network, they come into close contact with the surface of the substrate. This allows catalyst particles, amorphous carbon impurities, dispersants, and other impurities in the original CNT film to directly interact with the surface of the substrate and dissolve during the thermal treatment process. Consequently, this process removes impurities from the CNT FTCF and conspicuously enhances the purity of the assembled CNT FTCF. Because catalyst particles are often transition metals, particularly magnetic iron particles, it can be challenging to apply CNT FTCFs made by unpurified CNT dispersion in certain specialized scenarios. For instance, the presence of magnetic iron particles in the precision electron microscope chamber can lead to equipment damage. The potential applications for assembled continuous CNT network films in which catalyst particles and other impurities are eliminated will be more extensive.

4. Providing a superior growth platform for various functional composite FTCFs to achieve the production of functional composite films with higher quality.

This method achieve the fabrication of assembled CNT FTCF by utilizing driving of the facets, and different substrates can grow various other thin film materials, allowing for the development of large-area composite thin films with tightly connected continuous CNT networks with high quality, including but not limited to carbon materials, metal materials, semiconductors, and ceramics, such as copper and nickel substrates being suitable for graphene growth, which can be used to fabricate large-area continuous CNT network-graphene composite thin films. This composite thin film, due to the filling of CNT pores with graphene, can achieve higher carrier efficiency to enhance conductivity. After the substrate is removed, the mechanical strength provided by the assembled continuous CNT network is sufficient to support free-standing transfer on the surface of liquid, so the composite film can also be transferred to various agents for chemical treatment to further broaden the application range.

5. Being compatible with various CNT powders, suitable for various film formation methods, capable of being prepared in large areas, on a large scale and in an environmentally friendly manner.

The development of any new method for producing FTCF requires the ability to produce it on a large scale, even at an industrial scale for industrial significance since only large-area FTCF can meet the device and equipment needs of practical applications. Meanwhile, large-scale production is the only way leading industry to meet market demand, improve product quality, and reduce costs. However, there are very few new methods that can mass-produce or even scale up the production of FTCF at present.

The Preparation Method of assembled continuous CNT network film provided by the present invention can be scaled up for large-area or even mass production. By applying CNT dispersion onto the surface of the substrate to achieve a loosely X-type lap structure of CNTs and CNT bundles, the process becomes cost-effective, and the size of the substrate is not limited by space. The length and width can be expanded, allowing for easy preparation of free-standing CNT FTCFs with an area exceeding 1 cm×1 cm. This method is compatible with various types of CNTs, including single-walled, few-walled, multi-walled, and mixtures thereof, as well as various CNT dispersions such as gaseous, liquid (aqueous and organic), and powder spreading. It also accommodates various film formation methods including but not limited to airflow deposition of CNT powder, coating, blade coating, and spray coating of CNT dispersion. It should be noted that the pre-coating of CNT film on the surface of the substrate in this invention is only a preferred method, not a necessary step. Any CNT powder or its dispersion can be used for this method. For example, CNT powder can be directly placed onto the substrate, and then attached to the surface of the substrate by simple immersion and evaporation of an organic solvent. The CNT network can also be formed by assembly under driving of the facets. The purification effect of CNT in the assembly process of the CNT network makes the range of selectable CNT dispersion liquid quality greatly enlarged, allowing for a certain amount of impurities and pollution, thus saving the cost of purification, washing, and acid etching. The successful preparation of large-area CNT FTCF samples proves that this technology can be scaled up and even expanded to a large area.

Moreover, the method of the present invention avoids the use of any toxic or harmful substances, contributing to environmental protection in mass production. Our preparation process is entirely free from toxic or harmful substances, representing an environmentally friendly production approach that holds particular significance for future industrial production.

6. Optimizing the network structure to generate innovative concepts for FTCF design.

The CNT, CNT bundle assembly under driving of the facets provided by the present invention optimizes the network structure of CNT FTCF. Due to the formation and growth of the facets on the surface of the substrate, under driving of the facets, the majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. For some short CNTs, under the influence of driving of the facets, they gather at the grooves and depressions formed at the facet steps, and adjacent short CNTs or CNT bundles tend to converge towards each other, forming bundles of larger diameter constrained by van der Waals forces. With an appropriate CNT density, the larger-diameter bundles converge and form long bundles, encircling the facet steps. The long bundles form common segments at where they gather and pores at where they separate. The facets are in close proximity to one another, causing the pores to be adjacent to each other, making the adjacent long bundles form Y-type connections, thereby forming a continuous Y-type interconnected network. This is a more efficient conductive network and a more robust mechanical structure. Meanwhile, the CNTs and bundles with substantial defects are removed, resulting in slightly larger pore sizes in the assembled CNT network, but they will not exceed the size of the facet steps within the limitation of the facets, thus improving the uniformity of pore sizes. The optimized network structure enables the CNT FTCF to have improved performance synergistically in various aspects (transparency, conductivity, mechanical strength, purity, etc.).

Previous studies have involved heating CNT films/substrates under a protective reducing atmosphere. However, since a reducing atmosphere does not allow the presence of oxygen, no facet can be achieved. Consequently, the position of CNTs and their bundles remains unchanged, with minimal carbon consumption in the film. As a result, the network structure of the CNT FTCF before and after treatment remains essentially unchanged, making it challenging to optimize the film's network structure.

The optimization of the CNT network structure in the present invention not only provides a new perspective for the structural design and performance enhancement of FTCFs but also offers novel insights for the investigation of other types of films (such as high-strength films, ultra-flat films, etc.) and the removal of impurities in films.

The following describes the method for the large-scale fabrication of continuous CNT network films based on CNT powder in specific embodiments.

7. Flexibly adjust the areal density and porosity to enhance the performance of FTCF and broaden its application scope.

By modulating the density and length of the original CNT film, as well as the interaction conditions and duration between the facets and the CNTs (including impurities), the areal density and porosity of CNT FTCF can be precisely customized through the effect of driving of the facets. Areal density is of great significance for manufacturing lightweight and high-strength materials. For instance, in the rapidly advancing aerospace field, reducing areal density significantly decreases material weight over large areas, thereby lowering the overall mass of aircraft, improving fuel efficiency and range capability. Meanwhile, Weight reduction also effectively reduces launch costs, enhancing mission economic efficiency. Lighter materials enable aircraft to carry more payloads, such as scientific instruments, communication equipment, or additional fuel, thus further enhancing mission execution capabilities. Moreover, reduced inertia from weight reduction significantly improves aircraft maneuverability and control performance, and for space vehicles, it helps reduce propellant consumption required for attitude adjustment and orbit change. T Adjusting porosity allows CNT FTCF to be applied in various scenarios, such as achieving high transmittance for optical devices, high coverage for ultraviolet protection, and high uniformity to ensure more uniform thermal and electrical fields on surfaces of device, thereby extending service life. Combined with optimized mechanical and electrical properties, this material can meet the stringent requirements of the aerospace field for lightweight and high-performance composite materials, particularly showing broad prospects in applications such as space devices, aircraft structural components, electromagnetic shielding layers, and multifunctional skin materials. These advantages are expected to promote the development of more efficient, safer, and cost-effective aerospace designs.

### EMBODIMENTS

### Embodiment 1: Preparation Method of Assembled Continuous CNT Network Film Based on Direct Blade Coating

(1) Preparing a dispersion solution of CNTs (single-walled, 5-30 μm in length, tube diameter <2 nm) with a concentration of 0.2 mg/mL, where a surfactant is SDS (1 wt %) and a dispersant is an equal mixture of ethanol and water. Mixing them thoroughly and sonicating them for 4 hours.

(2) Performing electrochemical polishing on a copper foil to achieve a smooth surface.

(3) Laying the copper foil flat, and evenly blade coating the CNT dispersion liquid onto the surface of the copper foil. The samples are marked with numbers 1, 2, 3, 4, and 5, corresponding to the heights of the coating layers of 80, 100, 120, 160, and 200 μm, respectively.

(4) Allowing the sample to remain stationary and undergo natural drying to obtain a CNT film on the copper foil (i.e., CNT film/copper foil), to ensure that the surface resistance of the CNT film is consistently below 5000Ω/□. The measured initial areal density of the samples range approximately from 1.8 to 4.2 μg/cm². A few drops of ethanol are added to moisten the CNT film/copper foil to ensure better contact between the two.

(5) After the ethanol evaporates, placing the CNT film/copper foil into a chamber of a heating furnace. Using argon gas for purging the chamber to make the oxygen partial pressure in the chamber less than 10⁻² Torr. Setting up a heating program to heat the CNT film/copper foil.

When heating temperature reaches 700° C., as atoms or molecules constituting facets on the surface of the substrate undergo transport, interaction between the facets and the original CNT film commences. Due to the limited size of the facets at this stage, the overall probability of transported atoms or molecules interacting with the original CNT film is relatively low, rendering this interaction inconspicuous. At this stage, the CNTs in the original film are randomly and disorderly distributed and overlapped. Spaces between them are not continuous pores formed by a network structure, but rather random and minute gaps, even with impurities. Consequently, these characteristics prevent the attainment of desirable physical properties such as high light transmittance and robust mechanical performance. As the temperature continues to rise and exceed 700° C., the facets progressively increase in size, with their boundaries expanding. This expansion leads to the gradual convergence of boundaries between some or even most adjacent facets, resulting in the formation of distinct stepped or zigzag morphologies on the surface of the substrate. During the progressive growth of the facets, accompanied by the transport of atoms or molecules constituting facets, at least a portion of the CNTs in the original CNT film gradually adhere to the facets. As the facets grow, their boundaries expand and gradually converge until they eventually come into contact. The CNTs adhering to the facets, along with impurities in the original CNT film, are compelled to relocate by the expanding facet boundaries. This interaction between the facets and the CNTs results in the migration of some CNTs to the contact areas between the facets, leading to the initial formation of common segments of CNTs. Impurities move during the growth of facets, shortening the distance from the facets and facilitating the interaction between them, some impurities such as dispersants and organic substances are eliminated. Therefore, during this process, the arcal density of the film initially decreases. In this case, spaces between the CNTs expand resulted by the movement of CNTs and impurities, as well as the initial formation of common segments, thereby forming sporadically distributed individual or a few consecutive small pores that are small in size and limited in number. With further increase in temperature which is far above 700° C., the assembly process becomes increasingly conspicuous. This is manifested by the expansion of facet edges during heating, leading to increased contact areas between them. Under driving of the facets, some CNTs in the original CNT film continually adhere to the facets, subsequently moving and assembling to form extended common segments at the areas of contact. At this stage, the facets continuously dissolve impurities adhering to them, including defective CNTs, weak or thin CNTs, catalyst particles, and amorphous carbon, thereby facilitating the assembly of a portion of fresh Y-type interconnected continuous network with a long common segment. In this period, spaces between CNTs further expand. The pores begin to transition from sporadic distribution to many interconnected networks within localized regions, promoted by CNT movement, impurity elimination, and the initial formation of continuous network as the facets grow up.

Upon reaching a heating temperature of 900° C., the growth rate of the facets transitions from gradual to rapid and the edges of the facets contact with each other after expansion. As the contact areas continue to increase, the grooves and depressions between the facets form and eventually result in regular and well-aligned stepped or zigzag morphologies. During this process, the interactions between the original CNT film (containing impurities) and the facets become more conspicuous. The CNTs, along with their impurities, move and approach the facets under driving of the facets. The majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. Maintaining the temperature of 900° C. for 30 minutes, the original CNT film forms a large-area, Y-type interconnected network with a long common segment through the interaction between facets and the CNTs along with impurities within it. At this stage, a fully assembled CNT network has already formed. Consequently, the many small networks within localized regions evolve to extensively connected networks, eventually forming one fully interconnected network as the assembly process under driving of the facets proceeds in the isothermal duration. Since the pore boundaries in an assembled network are formed by either long common CNT segments and CNT Y-type connections in facet grooves and depressions or CNT bundles crossing several facets, or a combination of both, combined with the regulating conditions including the original CNT density and the assembly duration, their sizes are related to their possible geometries: narrow elongated pores matching single facet-terrace dimensions and wider expanded pores crossing multiple facet steps.

During this process, the impurities in the original CNT film are basically eliminated, further decreasing its areal density. Since the defective CNTs and bundles in the original CNTs are effectively eliminated owning to the tight adhesion to the facets resulted by driving of the facets, the pore diameters (also known as pore size) of the assembled network change. Meanwhile, with their boundaries mostly formed by long common CNT segments and CNT Y-type connections converging in facet grooves and depressions, the pores generally align along the edges of the facet steps, which means the pore size is constrained by driving of the facets as the facets grow and contact each other. Consequently, except for a few pore diameters that do not change conspicuously, most pore diameters become larger or smaller to a certain extent due to impurity elimination and facet constraints. Therefore, under the dual effect of eliminating impurities of various types (including dispersants, stabilizers, additives and other organic impurities from the raw materials, trace amounts of metals or inorganic salts, defective CNTs and bundles, thin and weak CNTs, catalyst particles and amorphous carbon within the CNTs) and facet boundary constraints, both of which are resulted from driving of the facets, the network structure of the assembled continuous CNT network film is optimized, and the pore diameter becomes more uniform.

(6) Once the heating process is complete, cooling the assembled continuous CNT network film/copper foil quickly to room temperature and then fetching them from the chamber.

(7) Placing the assembled continuous CNT network film/copper foil on an ammonium persulfate solution to etch off the copper foil, resulting in a floating continuous CNT network film on the surface of the ammonium persulfate solution. Finally, rinsing the film with deionized water to obtain a whole and free-standing assembled CNT FTCF. Transferring the free-standing assembled CNT FTCF to a quartz substrate for performance testing. The areal densities of the tested films are 1.1 μg/cm² (transmittance ˜90%) and 3.1 μg/cm² (transmittance ˜58%), respectively.

FIG. 6A shows an optical image of free-standing, floating assembled continuous CNT network films based on a direct blade coating method, and FIG. 6B shows an optical image of the assembled continuous CNT network films transferred to quartz substrates based on a direct blade coating method. As shown in FIGS. 6A and 6B, the two thinnest and most transparent samples (1st and 2nd samples) show excellent transparency and uniformity so as to be free-standing on the surface of water and transferred to quartz substrates without damage. FIG. 7 shows an optical image of the assembled continuous CNT network films transferred to quartz substrates with different transmittance based on a direct blade coating method. The samples, as illustrated in FIG. 7, can be described as follows: Sample 710, denoted as Sample 1, exhibits a transmittance of ˜90% at a wavelength of 550 nm and resistance of less than 1000Ω/□ without any treatment; Sample 720, referred to as Sample 2, demonstrates a transmittance of ˜85% at a wavelength of 550 nm; Sample 730, labeled as Sample 3, displays a transmittance of ˜78% at a wavelength of 550 nm; Sample 740, called sample 4, has the transmittance of ˜70% at a wavelength of 550 nm; and Sample 750, referred to as Sample 5, presents a transmittance of ˜55% at a wavelength of 550 nm. FIG. 8 shows the transparent conductivity performance of the assembled continuous CNT network films based on a direct blade coating method. According to FIG. 8, it is evident that samples 1-5 exhibit resistances of less than 1000Ω/□ without undergoing any treatment.

FIG. 9A shows an SEM image of the original X-type loosely lapped CNTs and CNT bundles, and FIG. 9B shows an SEM image of the assembled continuous CNT network film. Upon comparing FIG. 9A and FIG. 9B, it is evident that the pore sizes of the discrete and loosely X-type lapped original CNTs and bundles range from tens to hundreds of nanometers. The connections between CNTs and bundles are relatively loose, with some impurities present in the network. In contrast, the assembled CNT network predominantly exhibits pore sizes in the hundreds of nanometers which are larger, and the pores show improved size uniformity. The loose X-type lap joints between the original CNTs transform into a continuous Y-type interconnected network with a long common segment under driving of the facets. Furthermore, fewer impurities are observable in this network.

By utilizing CNT dispersions with higher quality (such as longer single-walled CNTs and improved dispersants) to effectively reduce the sheet resistance of the original CNT film in step (4), or performing appropriate treatment on the substrate (e.g., annealing or monocrystallization) to further regulate the facet structure, the transparency and conductivity of the resultant large-area continuous CNT network film will be conspicuously enhanced, thus obtaining large-area, free-standing assembled CNT FTCFs with transmittance exceeding 90% and sheet resistance below 100Ω/□ as well as transparent conductive films based on it.

### Embodiment 2: In Order to Exemplify the Enhancement Effect of the Facets on the Mechanical Properties of the Film, a Comparative Embodiment 2 is Proposed as Follows

(1) Preparing a dispersion solution of CNTs (single-walled, 5-30 μm in length, tube diameter <2 nm) with a concentration of 0.2 mg/mL, where a surfactant is SDS (1 wt %) and a dispersant is an equal mixture of ethanol and water. Mixing them thoroughly and sonicating them for 4 hours.

(2) Performing electrochemical polishing on a copper foil to achieve a smooth surface.

(3) Laying the copper foil flat, and evenly blade coating the CNT dispersion liquid onto the surface of the copper foil. The height of the coating layer is 160 μm.

(4) Allowing the sample to remain stationary and undergo natural drying to obtain a CNT film on the copper foil. A measured initial areal density of the sample is approximately 3.5 μg/cm². A few drops of ethanol are added to moisten a CNT film/copper foil to ensure better contact between the two.

(5) Placing the CNT film on the copper foil on an ammonium persulfate solution to etch off the copper foil. Rightly after etching off the copper foil, the CNT film breaks and shows visible cracks, as shown in FIG. 10 where the image is marked as 0s.

FIG. 10 is a set of optical images of the CNT film that is directly coated with the substrate removed immediately after the dispersion is dry without assembly process under driving of the facets. At 0s, no applied stress is introduced while the film cannot keep structural integrity due to its poor mechanical properties resulted from the discrete and loose X-type connections of CNTs. A glass plate is utilized to transfer the film to deionized water for rinsing. As the glass plate approaches the film, minor disturbance and stress exerted by the fluid cause it to further break, manifested by the increased number of cracks, as shown in the image marked as 3s. When the glass plate gets in touch with one side of the film, the film cannot keep the original shape and its fragments and cracked parts converge towards where the stress is lower, as shown in the image marked as 5s. In summary, FIG. 10 indicates that the CNT film in this embodiment cannot keep free-standing after etching of the copper foil, let alone the subsequent rinsing or transfer processes, wherein the arrows mark the cracks indicating fracture.

### Embodiment 3: In Order to Further Exemplify the Enhancement Effect of the Facets on the Physical Properties of the Film, and to Rule Out the Possibility that the Substrate Optimizes the Film Structure without Driving of the Facets Under High Temperature, a Comparative Embodiment 3 is Proposed as Follows

(1) Preparing a dispersion solution of CNTs (single-walled, 5-30 μm in length, tube diameter <2 nm) with a concentration of 0.2 mg/mL, where a surfactant is SDS (1 wt %) and a dispersant is an equal mixture of ethanol and water. Mixing them thoroughly and sonicating them for 4 hours.

(2) Performing electrochemical polishing on a copper foil to achieve a smooth surface.

(3) Evenly blade coating the CNT dispersion onto the surface of 2 pieces of copper foil, denoted as sample A₁ and sample A₂, with coated CNT dispersion height of 80 μm and 40 μm, respectively. The measured areal densities of the original CNT films are approximately 2.0 μg/cm² and 0.9 μg/cm², respectively.

(4) Allowing samples to stand still and dry naturally to obtain CNT film/copper foil (A₁ and A₂). Preferably, a few drops of ethanol are added to wet the samples for better contact.

(5) After the organic solvent evaporates, placing the samples into a chamber of a heating furnace. Keeping a flow rate of 40 sccm of hydrogen throughout the process, providing a reducing environment in the chamber, and setting the heating program as described in Embodiment 1. When the heating temperature exceeds 700° C., no facet appears on the surface of the copper foil. After the heating temperature reaches 900° C. and is maintained for 30 minutes, there is no facet observed, and CNTs and bundles are loosely X-typed lapped on the surface of copper, with impurities in the CNT film unable to adhere to the surface of copper. The movement of CNTs is minimal or nonexistent. As the temperature increases, there is still no facet observed, and there are no conspicuous changes observed in CNTs and bundles.

(6) Once the heating process is complete, cooling sample B to room temperature quickly and then fetching them from the chamber.

(7) Placing the samples on an ammonium persulfate solution to etch off the copper foil, resulting in a CNT film with cracks on the surface of the ammonium persulfate solution, then it broke apart during transfer to deionized water for rinsing, which means it cannot be frees-standing and transferred to a solid phase substrate (including quartz), and the situation is similar to Embodiment 2. Due to the fragmentation of the sample, the fragment area is very small, usually with a side length of millimeters, and fragments reaching a size of 1 cm side length are rare. From the fragmented samples A₁ and A₂, fragments with suitable sizes are selected for the characterization of transparent and conductive properties and are still denoted as A₁ and A₂. Additionally, a small fragment from Sample A₂ is chosen for structural characterization.

(8) Conducting transparent and conductive performance tests on Sample A₁ and A₂, and structural characterization on the small fragment from Sample A₂.

The SEM image of the small fragment is shown in FIG. 11A. As shown in FIG. 11A, it is evident that the CNTs exhibit a loosely X-type lapped structure instead of a tight and effective network, and the CNTs separate and disengage at the edge of the fragment. It indicates that the CNTs and CNT bundles in the small fragment have not been assembled into a CNT network. Consequently, numerous instances of fragmentation and disconnection occur during the transfer process in this embodiment.

The transparent conductive properties of samples A₁ and A₂ are shown in FIG. 11B. FIG. 11B shows the transparent conductivity performance of the CNT films without CNT network assembly. As shown in FIG. 11B, it demonstrates that the transmittance of Sample A₁ is 78%, the sheet resistance is 931Ω/□, which is more than 2 times higher than that of Sample 3 (258Ω/□, in FIG. 8) in Embodiment 1 with the same transmittance, and the transmittance is 12% lower than that of Sample 1 (90%, in FIG. 8) in Embodiment 1 with the same sheet resistance. The transmittance of Sample A₂ is 89%, and the sheet resistance is 2132 Ω/a, which is more than 2 times higher than Sample 1 in Embodiment 1 with similar transmittance. Evidently, the loosely X-type lapped CNTs and bundles fail to achieve high conductivity and transparency synergically due to absence of Y-type junctions and pore size adjustment by driving of facets. Through this comparative embodiment, it is proved that the assembly of the CNT continuous network under driving of the facets according to the method of the present invention conspicuously improves the physical properties of CNT FTCFs.

### Embodiment 4: Preparation Method of Assembled Continuous CNT Network Film Based on Powder Vapor Spraying

(1) Taking 0.3 g of CNT (a mixture of single-walled and multi-walled, 3-10 μm in length) and placing it into a chamber of a gas phase spraying apparatus. Introducing 1 L of nitrogen gas to form a circulating flow and mix the CNT thoroughly.

(2) Performing electrochemical polishing on a copper foil to achieve a smooth surface.

(3) Laying the copper foil flat, and using a vapor spraying apparatus to evenly spray a mixture of CNTs onto the surface of copper foil that has been heated to 60° C. and moistened with ethanol. The spraying amount is approximately 0.015 mg/cm².

(4) Allowing the sample to stand still, drying it naturally and cooling it to room temperature to obtain a CNT film/copper foil, with the CNT film sheet resistance lower than 5000 Ω/□.

(5) Placing the CNT film/copper foil into a chamber of a heating furnace. Using argon gas for purging the chamber to make the oxygen partial pressure in the chamber less than 10⁻² Torr. Setting up a heating program to heat the CNT film/copper foil.

When a heating temperature reaches 700° C., as atoms or molecules constituting facets on the surface of the substrate undergo transport, the interaction between the facets and the original CNT film commences. Due to the limited size of the facets at this stage, the overall probability of transported atoms or molecules interacting with the original CNT film is relatively low, rendering this interaction inconspicuous. At this stage, the CNTs in the original film are randomly and disorderly distributed and overlapped. The spaces between them are not continuous pores formed by a network structure, but rather random and minute gaps, even with impurities. Consequently, these characteristics prevent the attainment of desirable physical properties such as high light transmittance and robust mechanical performance. As the temperature continues to rise and exceed 700° C., the facets progressively increase in size, with their boundaries expanding. This expansion leads to the gradual convergence of boundaries between some or even most adjacent facets, resulting in the formation of distinct stepped or zigzag morphologies on the surface of the substrate. During the progressive growth of the facets, accompanied by the transport of atoms or molecules constituting facets, at least a portion of the CNTs in the original CNT film gradually adhere to the facets. As the facets grow, their boundaries expand and gradually converge until they eventually come into contact. The CNTs adhering to the facets, along with impurities in the original CNT film, are compelled to relocate by the expanding facet boundaries. This interaction between the facets and the CNTs results in the migration of some CNTs to the contact areas between the facets, leading to the initial formation of common segments of CNTs. Impurities move during the growth of facets, shortening the distance from the facets and facilitating the interaction between them, some impurities such as dispersants and organic substances are eliminated. Therefore, during this process, the areal density of the film initially decreases. In this case, spaces between the CNTs expand resulted by the movement of CNTs and impurities, as well as the initial formation of common segments, thereby forming sporadically distributed individual or a few consecutive small pores that are small in size and limited in number. With further increase in temperature which is far above 700° C., the assembly process becomes increasingly conspicuous. This is manifested by the expansion of facet edges during heating, leading to increased contact areas between them. Under driving of the facets, some CNTs in the original CNT film continually adhere to the facets, subsequently moving and assembling to form extended common segments at the areas of contact. At this stage, the facets continuously dissolve impurities adhering to them, including defective CNTs, weak or thin CNTs, catalyst particles, and amorphous carbon, thereby facilitating the assembly of a portion of fresh Y-type interconnected continuous network with a long common segment. In this period, spaces between CNTs further expand. The pores begin to transition from sporadic distribution to many interconnected networks within localized regions, promoted by CNT movement, impurity elimination, and the initial formation of continuous network as the facets grow up.

Upon reaching a heating temperature of 900° C., the growth rate of the facets transitions from gradual to rapid and the edges of the facets contact with each other after expansion. As the contact areas continue to increase, the grooves and depressions between the facets form and eventually result in regular and well-aligned stepped or zigzag morphologies. During this process, the interactions between the original CNT film (containing impurities) and the facets become more conspicuous. The CNTs, along with their impurities, move and approach the facets under driving of the facets. The majority of the CNTs migrate to the grooves between the facets and the depressions formed at the edges of the facets. Since the original CNTs are generally longer than the side lengths of the facets, some CNTs align tightly along the grooves and depressions to form long common segments and can cross the facets to tightly contact with other CNTs, thereby forming a Y-type interconnected network with a long common segment. Maintaining the temperature of 900° C. for 30-90 minutes, the original CNT film forms a large-area, Y-type interconnected network with a long common segment through the interaction between facets and the CNTs along with impurities within it. At this stage, a fully assembled CNT network has already formed. Consequently, the many small networks within localized regions evolve to extensively connected networks, eventually forming one fully interconnected network as the assembly process under driving of the facets proceeds in the isothermal duration. Since the pore boundaries in an assembled network are formed by either long common CNT segments and CNT Y-type connections in facet grooves and depressions or CNT bundles crossing several facets, or a combination of both, combined with the regulating conditions including the original CNT density and the assembly duration, their sizes are related to their possible geometries: narrow elongated pores matching single facet step dimensions and wider expanded pores crossing multiple facet steps.

During this process, the impurities in the original CNT film are basically eliminated, further decreasing its areal density. Since the defective CNTs and bundles in the original CNTs are effectively eliminated owning to the tight adhesion to the facets resulted by driving of the facets, the pore diameters (also known as pore size) of the assembled network change. Meanwhile, with their boundaries mostly formed by long common CNT segments and CNT Y-type connections converging in facet grooves and depressions, the pores generally align along the edges of the facet steps, which means the pore size is constrained by driving of the facets as the facets grow and contact each other. Consequently, except for a few pore diameters that do not change conspicuously, most pore diameters become larger or smaller to a certain extent due to impurity elimination and facet constraints. Therefore, under the dual effect of eliminating impurities of various types (including dispersants, stabilizers, additives and other organic impurities from the raw materials, trace amounts of metals or inorganic salts, defective CNTs and bundles, thin and weak CNTs, catalyst particles and amorphous carbon within the CNTs) and facet boundary constraints, both of which are resulted from driving of the facets, the network structure of the assembled continuous CNT network film is optimized, and the pore diameter becomes more uniform.

When the heating temperature reaches 1030° C., the morphological characteristics of the facets basically diminish. During this process, as the temperature approaches the melting point of copper foil, the pre-melting of copper foil becomes increasingly conspicuous, and the atomic or molecular transport at the facets intensifies. Residual impurities in the already formed CNT network, such as catalyst particles, defects, and weak CNTs, are further eliminated. This removal process intertwines with the earlier impurity elimination processes, ultimately preserving the assembled CNT network structure while almost completely eliminating impurities, thus enhancing pore size uniformity, and reducing the film's areal density. Consequently, a completely assembled continuous CNT network film is obtained.

FIG. 12 shows an SEM image of an assembled continuous CNT network film based on spray coating. As shown in FIG. 12, due to the tight connections formed by the assembled CNT network, the pore edges and CNT bundles will impede the diffusion of copper, resulting in the facets becoming small islands. The morphology of the assembled CNT network (the network distributed along the edge of the island) can be clearly observed in the flat areas surrounding the island, showing the tightly connected, Y-type interconnected continuous network with a long common segment as well as uniform pores.

(6) Once the heating process is complete, cooling the assembled continuous CNT network film/copper foil to room temperature quickly and then fetching them from the chamber.

(7) The assembled continuous CNT network film/copper foil is placed on an ammonium persulfate solution to etch off the copper foil, resulting in a floating continuous CNT network film on the surface of the ammonium persulfate solution. Finally, the film is rinsed with deionized water to obtain a free-standing assembled continuous CNT network film, as shown in FIG. 13. FIG. 13A shows an optical image of an assembled continuous CNT network film floating free-standing on ammonium persulfate, and FIG. 13B shows an optical image of an assembled continuous CNT network film floating free-standing on deionized water. From FIGS. 13A and 13B, it can be seen that the sample can be free-standing during transfer to deionized water and exhibits excellent transparency and uniformity.

### Embodiment 5: Preparation Method of Large-Area Assembled Continuous CNT Network Film Based on Direct Blade Coating

(1) Preparing a dispersion solution of CNTs (single-walled, 5-30 μm in length, tube diameter <2 nm) with a concentration of 0.2 mg/mL, where a surfactant is SDS (1 wt %) and a dispersant is an equal mixture of ethanol and water. Mixing them thoroughly and sonicating them for 4 hours.

(2) Performing electrochemical polishing on a copper foil to achieve a smooth surface.

(3) Laying the copper foil flat, and evenly blade coating the CNT dispersion liquid onto the surface of the large-area copper foil with a height of 80 μm.

(4) Allowing the copper foil with CNT dispersion to stand still, and waiting for natural drying to obtain a CNT film/copper foil, with the CNT film sheet resistances all being lower than 5000Ω/□. Preferably, a few drops of ethanol are added to moisten the CNT film/copper foil for better contact.

(5) In this embodiment, the operation process as well as the interaction process between the facets and CNTs or CNT bundles are the same as that described in step (5) of Embodiment 1 and will not be elaborated here.

(6) Once the heating process is complete, cooling the large-area assembled continuous CNT network film/copper foil to room temperature quickly and then fetching them from the chamber.

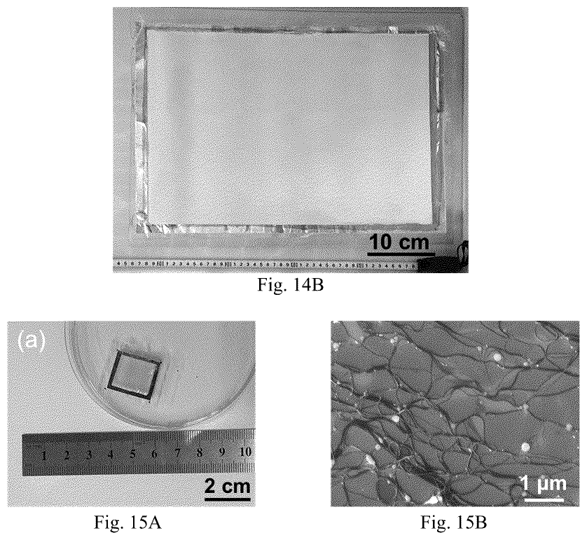

(7) The large-area assembled continuous CNT network film/copper foil is placed on an ammonium persulfate solution to etch off the copper foil, resulting in a floating large-area (>10 cm×10 cm) continuous CNT network film on the surface of the ammonium persulfate solution. Finally, the film is rinsed with deionized water to obtain a free-standing large-area (>10 cm²) assembled CNT FTCF, as shown in FIG. 14A. FIG. 14A shows an optical image of an assembled continuous CNT network film floating free-standing on deionized water.

### Embodiment 6: Preparation Method of Large-Area Assembled Continuous CNT Network Film Based on Powder Vapor Spraying

(1) Taking 3 g of CNT (single-walled, 3-10 μm in length) and placing it into a chamber of a gas phase spraying apparatus. Introducing 10 L of nitrogen gas to form a circulating flow and to mix the CNT thoroughly.

(2) Performing electrochemical polishing on a copper foil to achieve a smooth surface.

(3) Laying a large-area copper foil flat on the roller, and rotating it slowly under the drive of the motor. Using a vapor spraying apparatus to evenly spray a mixture of CNTs onto a surface of the copper foil that has been heated to 60° C. and moistened with ethanol. The spraying amount is approximately 0.02 mg/cm². The sprayed area should be allowed to dry and cool to room temperature before being rolled up on a roller.

(4) Unfolding the CNT film/copper foil after all areas are rolled up after spraying, with the CNT film sheet resistances all being lower than 5000Ω/□. Wrapping it with graphite paper and roll it up again. The graphite paper will separate the back of the rolled copper foil from the CNT film.

(5) In this embodiment, the operation process as well as the interaction process between the facets and CNTs or CNT bundles are the same as that described in step (5) of Embodiment 1 and will not be elaborated here.

(6) Once the heating process is complete, cooling the large-area assembled continuous CNT network film/copper foil to room temperature quickly and then fetching them from the chamber.

(7) The large-area assembled continuous CNT network film/copper foil is placed on an ammonium persulfate solution to etch off the copper foil, resulting in a floating large-area continuous CNT network film on the surface of the ammonium persulfate solution. Finally, the film is rinsed with deionized water to obtain a whole free-standing large-area (larger than A3 size, i.e., >30 cm×40 cm) assembled CNT FTCF. As shown in FIG. 14B, an optical image of an assembled continuous CNT network film floating free-standing on the surface of deionized water is presented.

### Embodiment 7: Preparation Method of Assembled Continuous CNT Network-graphene Composite Film Based on Assembled Continuous CNT Network

(1) Preparing a dispersion solution of CNTs (single-walled, 5-30 μm in length, tube diameter <2 nm) with a concentration of 0.2 mg/mL, where a surfactant is SDS (1 wt %) and a dispersant is an equal mixture of ethanol and water. Mixing them thoroughly and sonicating them for 4 hours.

(2) Performing electrochemical polishing on a copper foil to achieve a smooth surface.

(3) Laying the copper foil flat, and evenly blade coating the CNT dispersion liquid onto the surface of the copper foil with a height of 80 μm.

(4) Allowing the copper foil with CNT dispersion to stand still, and waiting for natural drying to obtain a CNT film/copper foil, with the CNT film sheet resistances all being lower than 5000Ω/□. Preferably, a few drops of ethanol are added to moisten the CNT film/copper foil for better contact.

(5) In this embodiment, the operation process as well as the interaction process between the facets and CNTs or CNT bundles are the same as that described in step (5) of Embodiment 4 and will not be elaborated here.

(6) Maintaining the temperature at 1030° C. for 10 minutes while simultaneously introducing 2 sccm of methane and 40 sccm of hydrogen to facilitate graphene growth.

(7) Once the heating process is complete, cooling the assembled continuous CNT network-graphene composite film/copper foil based on the assembled continuous CNT network to room temperature quickly and then fetching them from the chamber.

(8) The assembled continuous CNT network-graphene composite film/copper foil based on assembled continuous CNT network is placed on an ammonium persulfate solution to etch off the copper foil, resulting in a floating assembled continuous CNT network-graphene composite film based on assembled continuous CNT network on the surface of the ammonium persulfate solution. Finally, the film is rinsed with deionized water to obtain a free-standing assembled continuous CNT network-graphene composite FTCF based on assembled continuous CNT network, as shown in FIG. 15. FIG. 15A shows an optical image of an assembled continuous CNT network-graphene film floating free-standing on deionized water, and FIG. 15B shows an SEM image of an assembled continuous CNT network-graphene film.

### Embodiment 8: Preparation Method of Assembled Continuous CNT Network Film Based on Carrier Gas Blowing on Nickel Foil

(1) Growing CNTs using a vapor phase decomposition method.

(2) Performing electrochemical polishing on a nickel foil to achieve a smooth surface.

(3) Using a carrier gas containing CNTs to uniformly blow and sweep nickel foil, allowing the CNTs to adhere to the surface of nickel foil. The blowing amount is approximately 0.02 mg/cm² to obtain the original CNT film. Preferably, a few drops of acetone are added to moisten the CNT film/nickel foil for better contact.

(4) After the organic solvent evaporates, placing the CNT film/nickel foil into a chamber of a heating furnace. Purging the chamber to make the oxygen partial pressure in the chamber less than 1 Torr. Setting up a heating program to heat the CNT film/nickel foil. When the heating temperature reaches 800° C., facets emerge on the surface of the nickel foil. With the temperature raised to 900° C., these facets gradually increase in size. Upon reaching a heating temperature of 1000° C., the facets are already grown and interact with CNTs, resulting in relocation and assembly of the loose CNTs into a continuous network. Maintaining the temperature at 1000° C. for 30 minutes to acquire sufficient time for facet growth and the assembly of CNTs under driving of the facets.

In this embodiment, the interaction process between the facets and CNTs or CNT bundles are the same as that described in step (5) of Embodiment 1 and will not be elaborated here.

(6) Once the heating process is complete, cooling the assembled continuous CNT network film/nickel foil to room temperature quickly and then fetching them from the chamber.

(7) The assembled continuous CNT network film/nickel foil is placed on an ammonium persulfate solution to etch off the nickel foil, resulting in a floating continuous CNT network film on the surface of the ammonium persulfate solution. Finally, the film is rinsed with deionized water to obtain a free-standing assembled CNT FTCF.

### Embodiment 9: Preparation Method of Assembled Continuous CNT Network Film Based on Carrier Gas Blowing on Platinum Foil

(1) Growing CNTs using a vapor phase decomposition method.

(2) Performing electrochemical polishing on a platinum foil to achieve a smooth surface.

(3) Using a carrier gas containing CNTs to uniformly blow and sweep platinum foil, allowing the CNTs to adhere to the surface of platinum foil. The blowing amount is approximately 0.03 mg/cm² to obtain the original CNT film. Preferably, a few drops of acetone are added to moisten the CNT film/platinum foil for better contact.

(4) After the organic solvent evaporates, placing the CNT film/platinum foil into a chamber of a heating furnace. Purging the chamber to make the oxygen partial pressure in the chamber less than 1 Torr. Setting up a heating program to heat the CNT film/platinum foil. When the heating temperature reaches 1000° C., facets emerge on the surface of the platinum foil. With the temperature raised to 1100° C., these facets gradually increase in size. Upon reaching a heating temperature of 1300° C., the facets are already grown and interact with CNTs, resulting in relocation and assembly of the CNTs into a continuous network. Maintaining the temperature at 1300° C. for 30 minutes to acquire sufficient time for facet growth and the assembly of CNTs under driving of the facets.

In this embodiment, the interaction process between the facets and CNTs or CNT bundles are the same as that described in step (5) of Embodiment 1 and will not be elaborated here.

(6) Once the heating process is complete, cooling the assembled continuous CNT network film/platinum foil to room temperature quickly and then fetching them from the chamber.

(7) The assembled continuous CNT network film/platinum foil is placed on an ammonium persulfate solution to etch off the platinum foil, resulting in a floating continuous CNT network film on the surface of the ammonium persulfate solution. Finally, the film is rinsed with deionized water to obtain a free-standing assembled CNT FTCF.

By this point, those skilled in the art should recognize that, although numerous exemplary embodiments of the present invention have been shown and described in detail herein, many other variations or modifications consistent with the principles of the invention may be directly determined or inferred from the information provided herein without departing from the spirit and scope of the invention. Accordingly, it is to be understood that the scope of the invention encompasses all such other variations or modifications.

What is claimed is:

1. A method for preparing a continuous carbon nanotube (CNT) network film, comprising:
preparing CNT dispersion by placing a preset amount of CNT powder in a preset dispersion medium;
obtaining an original CNT film with discrete and loosely lapped CNTs by placing the CNT dispersion on a surface of a substrate;
placing the original CNT film and the substrate into a chamber of a heating furnace; and
setting up a heating program to initiate an interaction between the original CNT film and the substrate, thereby assembling the CNTs in the original CNT film into an assembled continuous CNT network film.

2. The method as claimed in claim 1,
wherein the steps following placing the CNT dispersion on a surface of a substrate further comprise:
dripping a volatile organic solvent onto the original CNT film to infiltrate the original CNT film to increase the contact between the discrete and loosely lapped CNTs and the substrate; and
performing the step of placing the original CNT film and the substrate into a chamber of a heating furnace after the organic solvent is volatilized.

3. The method as claimed in claim 2,
wherein CNTs in the CNT powder comprise at least any one, or a mixture of any combination of the following: single-walled, double-walled, few-walled, and multi-walled CNTs;
an areal density of dispersed CNTs exceeds a predetermined value, resulting in a sheet resistance of less than 10,000Ω/□ after the dispersion is placed on the surface of the substrate;
the CNT dispersion comprises dispersion in atmosphere, dispersion in liquid or spreading of CNT powder;
a method of placing the CNT dispersion on the surface of the substrate includes any one, or any combination of the following methods: fluidized bed vapor deposition, powder coating deposition, powder vapor spraying, coating, blade coating, spraying, drop casting, centrifugal film deposition, and powder dipping.

4. The method as claimed in claim 1,
wherein processes of initiating the interaction between the original CNT film and the substrate include:
allowing the substrate to undergo surface reconstruction in the presence of gas in the chamber of the heating furnace during heating to form a microstructure called a “facet” concurrent with transport of atoms constituting facets, the facets showing a regular stepped or zigzag pattern at a mesoscopic scale on the surface of the substrate; and
allowing the facets to interact with the original CNT film to eliminate impurities from the original CNT film, and to compel at least a portion of the CNTs in the original CNT film to relocate, thereby making adjacent CNTs or bundles turn into tight proximity, facilitating the assembly of CNTs in the original CNT film to form a continuous network, thus obtaining the assembled continuous CNT network film.

5. The method as claimed in claim 4,
wherein the gas is a gas, in the chamber of the heating furnace, that is capable of interacting with the substrate to initiate the surface reconstruction, and includes any one or a mixture of oxidizing gases, or any one or a mixture of reducing gases;
a source of the gas includes any one of forms of gas, liquid, and solid, or any combination of the above multiple forms.

6. The method as claimed in claim 5,
wherein allowing the substrate to undergo surface reconstruction in presence of gas in the chamber of the heating furnace during heating to form the facets includes:
purging the chamber of the heating furnace to regulate a partial pressure of the gas in the chamber of the heating furnace, which can interact with the substrate to result in the surface reconstruction, to be within a predetermined range; and
heating the chamber to control the substrate to undergo surface reconstruction with the gas, so as to form the facets.

7. The method as claimed in claim 6,
wherein allowing the facets to interact with the original CNT film includes:
continuing heating the chamber to promote gradual growth of the facets on the surface of the substrate, thereby facilitating gradual tight adhesion of at least a portion of the CNTs in the original CNT film to the facets, as well as gradual dissolution of impurities within the original CNT film; and
the CNTs in the original CNT film moving closer to each other as the facets grow up, leading to assembly of the CNTs into a Y-type interconnected network with a long common segment under driving of the facets, thus obtaining a whole assembled continuous CNT network film.

8. The method as claimed in claim 4,
wherein after allowing the facets to interact with the original CNT film, the method further comprises:
cooling the assembled continuous CNT network film at a preset cooling rate; and
etching the substrate from the assembled continuous CNT network film by placing them in a substrate etchant after cooling, allowing the assembled continuous CNT network film to float on surface of the substrate etchant, and then rinsing the film.

9. The method as claimed in claim 1,
wherein before placing the CNT dispersion on the surface of the substrate, the method further comprises:
pretreating the substrate to make a surface of the substrate smooth by any one of methods including mechanical polishing, electrochemical polishing, and high-temperature annealing or a combination of any of the above methods.
